(19) United States
(12) Patent Application Publication
(10) Pub. No.: US 2025/0119947 A1
(43) Pub. Date: Apr. 10, 2025

(54) BEAM ASSOCIATION FOR A FIXED FRAME PERIOD

(71) Applicant: Lenovo (Singapore) Pte. Ltd., New Tech Park (SG)

(72) Inventors: Ankit Bhamri, Rödermark (DE); Hossein Bagheri, Urbana, IL (US); Alexander Golitschek Edler von Elbwart, Darmstadt (DE); Karthikeyan Ganesan, Kronberg im Taunus (DE); Ali Ramadan Ali, Kraiburg am Inn (DE); Hyejung Jung, Northbrook, IL (US)

(21) Appl. No.: 18/293,747

(22) PCT Filed: Aug. 1, 2022
(86) PCT No.: PCT/IB2022/057136

§ 371 Date: Jan. 30, 2024

Related U.S. Application Data
(60) Provisional application No. 63/227,957, filed on Jul. 30, 2021.

(51) Int. Cl. H04W 74/0816; H04B 7/06; H04W 16/28

(52) U.S. Cl. CPC H04W 74/0816; H04B 7/06968; H04W 16/28

(57) ABSTRACT

Apparatuses, methods, and systems are disclosed for semi-static channel access with directional FFP. One method (800) includes receiving (805) a configuration for a plurality of FFPs, where each FFP is associated with a separate transmit beam for transmission within that FFP. The method (800) includes identifying (810) an initiated FFP and performing (815) communication activity during the initiated FFP using a beam corresponding to the initiated FFP, where the communication activity includes a transmission, a reception, or a combination thereof.

### CROSS-REFERENCE TO RELATED APPLICATIONS

This application claims priority to U.S. Provisional Patent Application No. 63/227,957 entitled “SEMI-STATIC CHANNEL ACCESS WITH DIRECTIONAL FIXED FRAME PERIOD” and filed on 30 Jul. 2021 for Ankit Bhamri, Hossein Bagheri, Alexander Golitschek Edler von Elbwart, Karthikeyan Ganesan, Ali Ramadan Ali, Hyejung Jung, which application is incorporated herein by reference.

### FIELD

The subject matter disclosed herein relates generally to wireless communications and more particularly relates to using semi-static channel access with directional (i.e., beam-based) fixed frame period (“FFP”).

### BACKGROUND

In certain wireless communications networks, devices may communicate using unlicensed (i.e., shared) spectrum. For operation in unlicensed spectrum, when semi-static channel access is used (i.e., operation according to Frame-Based Equipment (“FBE”)), downlink (“DL”) and uplink (“UL”) transmissions are allowed within a fixed frame period (“FFP”) that a device has acquired, e.g., via channel sensing techniques.

### BRIEF SUMMARY

Disclosed are procedures for semi-static channel access with directional FFP. Said procedures may be implemented by apparatus, systems, methods, or computer program products.

One method at a User Equipment (“UE”) includes receiving a configuration for a plurality of fixed frame periods (“FFPs”), where each FFP is associated with a separate transmit beam for transmission within that FFP. The method includes identifying an initiated FFP and performing communication activity during the initiated FFP using a beam corresponding to the initiated FFP, where the communication activity includes a transmission, a reception, or a combination thereof.

One method at a network device includes transmitting a configuration for a plurality of FFPs to a UE, where each FFP is associated with a separate transmit beam for transmission within that FFP. The method includes identifying an initiated FFP and performing communication activity with the UE during the initiated FFP using a beam corresponding to the initiated FFP, where the communication activity includes a transmission, a reception, or a combination thereof.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A is a schematic block diagram illustrating one embodiment of a wireless communication system for semi-static channel access with directional FFP;

FIG. 1B is a diagram illustrating one embodiment a fixed frame period (“FFP”) structure;

FIG. 1C is a diagram illustrating one embodiment of multiple transmissions in the same FFP;

FIG. 2 is a diagram illustrating one embodiment of a New Radio (“NR”) protocol stack;

FIG. 3 is a diagram illustrating one embodiment of two FFPs associated with two beams and same FFP configurations;

FIG. 4 is a diagram illustrating one embodiment of two FFPs associated with two beams and different FFP configurations;

FIG. 5A is a diagram illustrating one embodiment of one FFP is associated with multiple beams;

FIG. 5B is a diagram illustrating one embodiment of a UE communicating using multiple beams;

FIG. 6 is a block diagram illustrating one embodiment of a user equipment apparatus that may be used for semi-static channel access with directional FFP;

FIG. 7 is a block diagram illustrating one embodiment of a network apparatus that may be used for semi-static channel access with directional FFP;

FIG. 8 is a flowchart diagram illustrating one embodiment of a first method for semi-static channel access with directional FFP; and

FIG. 9 is a flowchart diagram illustrating one embodiment of a second method for semi-static channel access with directional FFP.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for selecting a fixed frame period operation for uplink transmission. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

For operation in unlicensed spectrum, when semi-static channel access is used (e.g., FBE operation), DL and UL transmissions are allowed within a frame period (“FP”) that a gNB (i.e., a 5th Generation (“5G”) base station) or a UE has acquired, e.g., via channel sensing techniques.

One benefit of UE-initiated Channel Occupancy Time (“COT”) is the reduced latency of the configured grant (“CG”) Physical Uplink Shared Channel (“PUSCH”) transmission. Because the gNB may not be aware if there is any data to be transmitted by the UE, and the gNB may not have any DL data, control, or reference signal to transmit (or UL data, control, or reference signal to schedule). Hence, the gNB may not sense the channel to acquire a COT. By allowing some of the UEs in a cell-in certain conditions-to initiate a COT (instead of allowing all/many UEs to initiate a COT) at the beginning of a frame period may have certain advantages, such as allowing UEs to have latency sensitive data to transmit their UL data/control first by avoiding collision with other UEs which might have data/control that can tolerate some latency.

When COT sharing with the gNB is desired for the UE-initiated COT, a first UL burst sent by the UE initiating the COT should not take most of the acquired FFP; otherwise, there will not be many time resources left for COT sharing.

In Third Generation Partnership Project (“3GPP”) New Radio (“NR”) systems, channel access mechanisms for unlicensed access in the 60 GHz band and above may be supported for directional LBT and no-LBT based mechanisms. Additionally, ultra-reliable low-latency communication (“URLLC”) operation in unlicensed bands in Frequency Range #1 (“FR1”, i.e., frequencies from 410 MHz to 7125 MHz) may support semi-static channel access including both gNB-initiated FFP and UE-initiated FFP.

For future wireless systems, some companies have expressed interest to further enhance support for URLLC operations in Frequency Range #2 (“FR2”, i.e., frequencies from 24.25 GHz to 52.6 GHz) including unlicensed bands, as well such in the 60 GHz bands and beyond. It is expected that in Rel-18 or beyond, URLLC support in FR2 will be further considered including unlicensed bands in FR2 with directional LBT and/or no-LBT.

Described herein are solutions to support semi-static channel access with directional LBT. Particularly, we describe FFP-related enhancements when directional LBT is performed and describe solutions to handle FFP initiation and/or FFP sharing between an initiating device and a responding device.

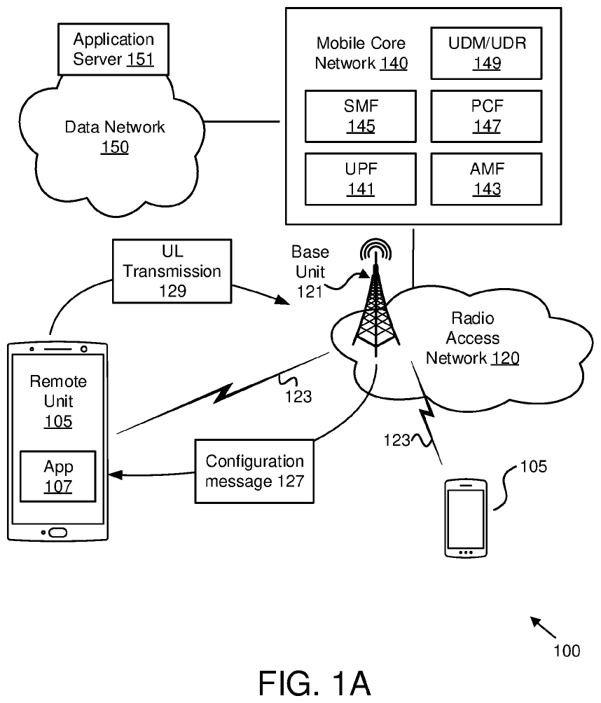

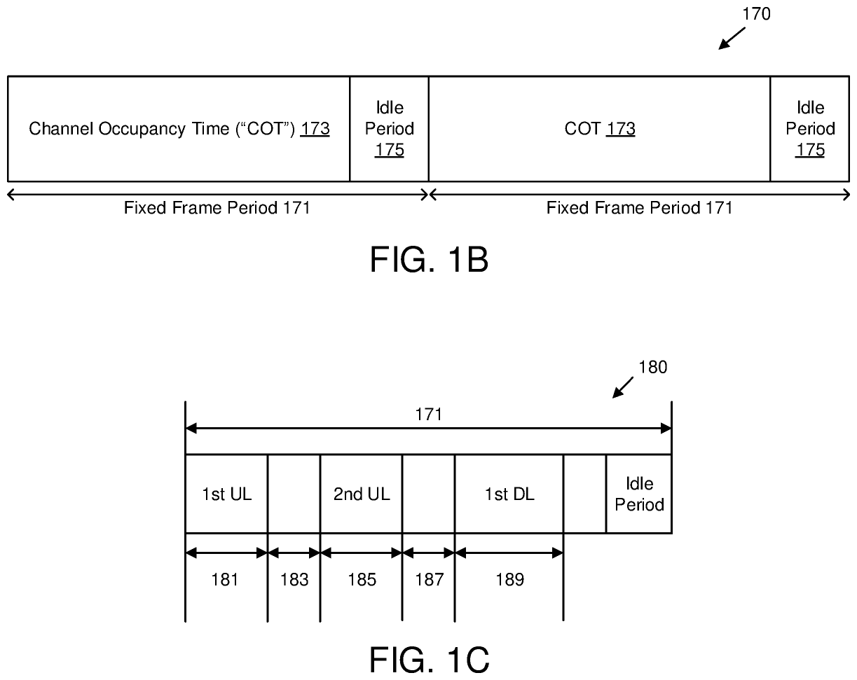

FIG. 1A depicts a wireless communication system 100 for semi-static channel access with directional FFP, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1A, one of skill in the art will recognize that any number of remote units 105, base units 121, wireless communication links 123, RANs 120, and mobile core networks 140 may be included in the wireless communication system 100.

In one implementation, the RAN 120 is compliant with the Fifth-Generation (“5G”) cellular system specified in the Third Generation Partnership Project (“3GPP”) specifications. For example, the RAN 120 may be a Next Generation Radio Access Network (“NG-RAN”), implementing New Radio (“NR”) Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Furthermore, the UL communication signals may comprise one or more uplink channels, such as the Physical Uplink Control Channel (“PUCCH”) and/or Physical Uplink Shared Channel (“PUSCH”), while the DL communication signals may comprise one or more downlink channels, such as the Physical Downlink Control Channel (“PDCCH”) and/or Physical Downlink Shared Channel (“PDSCH”). Here, the RAN 120 is an intermediate network that provides the remote units 105 with access to the mobile core network 140.

In various embodiments, the remote units 105 may communicate directly with each other (e.g., device-to-device communication) using sidelink communication 113. Here, sidelink transmissions may occur on sidelink resources. A remote unit 105 may be provided with different sidelink communication resources according to different allocation modes. As used herein, a “resource pool” refers to a set of resources assigned for sidelink operation. A resource pool consists of a set of resource blocks (i.e., Physical Resource Blocks (“PRB”)) over one or more time units (e.g., subframe, slots, Orthogonal Frequency Division Multiplexing (“OFDM”) symbols). In some embodiments, the set of resource blocks comprises contiguous PRBs in the frequency domain. A PRB, as used herein, consists of twelve consecutive subcarriers in the frequency domain.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or Packet Data Network (“PDN”) connection) with the mobile core network 140 via the RAN 120. The PDU session represents a logical connection between the remote unit 105 and the User Plane Function (“UPF”) 141. The mobile core network 140 then relays traffic between the remote unit 105 and the application server 151 in the packet data network 150 using the PDU session (or other data connection).

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific Qos Flow have the same 5G QOS Identifier (“5QI”).

In the context of a 4G/LTE system, such as the Evolved Packet System (“EPS”), a PDN connection (also referred to as EPS session) provides E2E UP connectivity between the remote unit and a PDN. The PDN connectivity procedure establishes an EPS Bearer, i.e., a tunnel between the remote unit 105 and a PDN Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121.

Note that during NR operation on unlicensed spectrum (referred to as “NR-U”), the base unit 121 and the remote unit 105 communicate over unlicensed (i.e., shared) radio spectrum. Similarly, during LTE operation on unlicensed spectrum (referred to as “LTE-U”), the base unit 121 and the remote unit 105 also communicate over unlicensed (i.e., shared) radio spectrum.

In one embodiment, the mobile core network 140 is a 5G Core network (“5GC”) or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR”). In some embodiments, the UDM is co-located with the UDR, depicted as combined entity “UDM/UDR” 149. Although specific numbers and types of network functions are depicted in FIG. 1A, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Spectrum (“NAS”) signaling, NAS ciphering and integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation and management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1A for ease of illustration, but their support is assumed.

While FIG. 1A depicts components of a 5G RAN and a 5G core network, the described embodiments for semi-static channel access with directional FFP apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

As described in greater detail below, the base unit 121 may send a configuration message 127 to a remote unit 105, with the remote unit 105 receiving a first configuration for a Fixed Frame Period (“FFP”). The remote unit 105 may be configured with more than one fixed frame period for semi-static channel access, where each configured FFP is associated with a specific beam (or Transmission Configuration Indicator (“TCI”) state) to allow UL transmission(s) 129 on a corresponding beam (or TCI state) within that FFP from the remote unit 105 to the base unit 121.

In the following descriptions, the term “gNB” is used for the base station/base unit, but it is replaceable by any other radio access node, e.g., RAN node, ng-eNB, eNB, Base Station (“BS”), Access Point (“AP”), NR BS, 5G NB, Transmission and Reception Point (“TRP”), etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems for semi-static channel access with directional FFP.

It should be mentioned that throughout the disclosure, the terms symbol, slot, subslot and transmission time interval (“TTI”) refers to a time unit with a particular duration (e.g., symbol could be a fraction/percentage of an orthogonal frequency division multiplexing (“OFDM”) symbol length associated with a particular subcarrier spacing (“SCS”)). Please note that throughout this document, the terms “beam,” “QCL type-D assumption,” and/or “TCI state” are interchangeably used as each relates to Spatial Division Multiplexing (“SDM”).

In the following, an UL transmission (e.g., UL transmission burst) may be comprised of multiple transmissions (e.g., of the same or different priority, in case a priority is associated with the transmissions) with gaps between the transmissions, wherein the gaps are short enough in duration to not necessitate performing a channel sensing operation (e.g., Listen-Before-Talk (“LBT”) or Clear Channel Assessment (“CCA”)) between the transmissions.

In the following, an UL transmission may refer to a PUSCH transmission, a PUCCH transmission, Random Access Channel (“RACH”) transmission, and/or an UL signal. In certain embodiments, an UL transmission may contain Uplink Control Information (“UCI”), such as Configured Grant UCI (“CG-UCI”) containing information regarding the acquired COT such as COT sharing information. In certain embodiments, the UL transmission may contain Scheduling Request (“SR”) or periodic Channel State Information (“CSI”) or semi-persistent CSI. Throughout the disclosure, sometimes CO and COT are used interchangeably. It should be noted that the below described embodiments, examples, and implementations, may also be applicable to sidelink transmissions.

Devices/network nodes, such as gNBs, that operate in unlicensed/shared spectrum may be required to perform LBT (also referred to as “channel sensing”) prior to being able to transmit in the unlicensed spectrum. If the device/network node performing LBT does not detect the presence of other signals in the channel, the medium/channel is considered for transmission.

FIG. 1B depicts an exemplary structure 170 for a Fixed Frame Period (“FFP”) 171. The FFP 171 is comprised of a Channel Occupancy Time (“COT”) 173 and an idle period 175. In FBE (frame-based equipment) mode of operation, the UE or gNB performs LBT in an idle period 173 and upon acquiring the channel/medium, the UE or gNB can communicate within the non-idle time of a fixed frame period duration (referred to as channel occupancy time (“COT”) 173). In current specifications/regulations, the duration of the idle period 175 is not to be shorter than the maximum of: 5% of the FFP 171, and 100 microseconds (“μs”).

When a gNB operates as an initiating device for semi-static channel access mode, the gNB may not be allowed to transmit during the idle period of any FFP associated with the gNB in which the gNB initiates a COT. When a UE operates as an initiating device for semi-static channel access mode, the UE is not allowed to transmit during the idle period of any FFP associated with the UE in which the UE initiates a COT.

Regarding LBT categories, Category 2 (“Cat-2”) LBT refers to LBT procedure without random back-off, Category 3 (“Cat-3”) LBT refers to LBT procedure with random back-off with a fixed contention window size, and Category 4 (“Cat-4”) LBT refers to LBT procedure with random back-off with variable contention window size.

Regarding COT with Multi-User, Multiple-Input, Multiple-Output (“MU-MIMO”) (i.e., SDM) transmission, a system may support single LBT sensing at the start of the COT with wide beam ‘cover’ all beams to be used in the COT with appropriate energy detection threshold. In certain embodiments, a system may support independent per-beam LBT sensing at the start of COT is performed for beams used in the COT.

Within a COT with TDM of beams with beam switching, one or more of the following LBT operations may be supported. Case #1: Single LBT sensing with wide beam ‘cover’ all beams to be used in the COT with appropriate ED threshold; Case #2: Independent per-beam LBT sensing at the start of COT is performed for beams used in the COT; and/or Case #3: Independent per-beam LBT sensing at the start of COT is performed for beams used in the COT with additional requirement on Cat-2 LBT before beam switch.

For a COT with MU-MIMO (i.e., SDM) transmission, when independent per-beam LBT sensing at the start of COT is performed for beams used in the COT is considered, the following options may be supported. Option A: The per-beam LBT for different beams is performed in TDM fashion; Option A-1: The node completes one Enhanced Clear Channel Assessment (“eCCA”) on one beam, and directly move on to the eCCA on the other beam, with no transmission in the middle; Option A-2: The node completes one eCCA on one beam, start transmission with the beam to occupy the COT, then move on to the eCCA on the other beam; Option A-3: The node performs eCCA of the different beams simultaneously, and according to a round robin scheduling between different beams; Option B: The per-beam LBT for different beams is performed simultaneously in parallel, assuming the node has the capability to simultaneously sense in different beams.

Within a COT with TDM of beams with beam switching, when independent per-beam LBT sensing at the start of COT is performed for beams used in the COT is considered, the following options may be supported. Option A: The per-beam LBT for different beams is performed one after another in time domain; Option A-1: The node completes one eCCA on one beam, and directly moves on to the eCCA on the other beam, with no transmission in the middle; Option A-2: The node completes one eCCA on one beam, starts transmission with the beam to occupy the COT, then moves on to the eCCA on the other beam; Option A-3: The node performs eCCA of the different beams simultaneously, and according to a round robin scheduling between different beams; Option B: The per-beam LBT for different beams is performed simultaneously in parallel, assuming the node has the capability to simultaneously sense in different beams.

FIG. 1C depicts an example scenario 180 where multiple transmissions are made on the same COT. In one embodiment, the example scenario 180 represents multiple uplink and/or downlink (“UL/DL”) transmission bursts. In another embodiment, the example scenario 180 represents COT sharing. In various embodiments, LBT is not required for some gaps of an FFP 171. For example, LBT may not be required for a first gap 183 between a first UL transmission 181 and a second UL transmission 185 if the first gap 183 is below a threshold amount. In certain embodiments, LBT category or LBT parameters are determined based on the FFP type.

Regarding channel access in NR Rel-17 for 60 GHz and above, in some embodiments there may be a maximum gap within a COT to allow COT sharing without additional LBT. In one embodiment, a maximum gap X is defined, such that a later transmission can share the COT without LBT only if the later transmission starts within X from the end of the earlier transmission. In another embodiment, a maximum gap Y is defined, such that a later transmission can share the COT without LBT only if the later transmission starts within Y from the end of the earlier transmission. If the later transmission starts after Y from the end of the earlier transmission, a one-shot LBT is needed to share the COT. In other embodiments, no maximum gap is defined. Here, a later transmission can share the COT without LBT with any gap within the maximum COT duration.

In the example scenario 180, the LBT requirement on the first gap 183 between the first UL transmission 181 and the second UL transmission 185 for the UE initiating the COT may be different than the LBT requirement on other gaps between UL transmissions and DL transmissions (e.g., due to location of PDCCH monitoring occasions/collision between multiple UEs initiating a same COT). For example, for the UE initiating a COT, the gap duration for a second gap 187 between the second UL transmission 185 and the first DL transmission 189 for which LBT is required is larger than the gap duration between subsequent UL/DL transmissions.

Regarding unlicensed/shared spectrum technology, the following terminologies are defined:

A “channel” refers to a carrier or a part of a carrier consisting of a contiguous set of resource blocks (“RBs”) on which a channel access procedure is performed in shared spectrum.

A “channel access procedure” refers to a sensing-based procedure that evaluates the availability of a channel for performing transmissions. The basic unit for sensing is a sensing slot with a duration Tₛₗ=9 μs. The sensing slot duration Tₛₗ is considered to be idle if an eNB/gNB or a UE senses the channel during the sensing slot duration, and determines that the detected power for at least 4 μs within the sensing slot duration is less than energy detection threshold X_{Thresh}. Otherwise, the sensing slot duration Tₛₗ is considered to be busy.

A “channel occupancy” refers to transmission(s) on channel(s) by eNB(s)/gNB(s) or UE(s) after performing the corresponding channel access procedures, e.g., as described in 3 GPP Technical Specification (“TS”) 37.213.

A “Channel Occupancy Time” refers to the total time for which the initiating eNB/gNB or UE and any eNB(s)/gNB(s) or UE(s) sharing the channel occupancy perform transmission(s) on a channel, i.e., after an eNB/gNB or UE performs the corresponding channel access procedures described in this clause. For determining a Channel Occupancy Time, if a transmission gap is less than or equal to 25 μs, the gap duration is counted in the channel occupancy time. A channel occupancy time can be shared for transmission between an eNB/gNB and the corresponding UE(s).

A “DL transmission burst” is defined as a set of transmissions from an eNB/gNB without any gaps greater than 16 μs. Transmissions from an eNB/gNB separated by a gap of more than 16 μs are considered as separate DL transmission bursts. An eNB/gNB may transmit transmission(s) after a gap within a DL transmission burst without sensing the corresponding channel(s) for availability.

A “UL transmission burst” is defined as a set of transmissions from a UE without any gaps greater than 16 μs. Transmissions from the same UE which are separated by a gap of more than 16 μs are considered as separate UL transmission bursts. A UE may transmit subsequent transmission(s) after a gap within a UL transmission burst without sensing the corresponding channel(s) for availability.

A UE may perform channel sensing and access the channel if it senses the channel to be idle. UE-initiated COT may be especially useful in low-latency applications, wherein the UE having UL data to be sent in configured grant resources is allowed to initiate a COT. Sometimes, it is useful to share the acquired COT with the gNB, such that gNB could schedule DL or UL for the same UE or for other UEs.

Note that a UE may have up to 12 simultaneously active configured grants for a bandwidth part (“BWP”) of a serving cell. Each configured grant may have a physical layer priority indicator (e.g., phy-PriorityIndex-r16). In certain embodiments, a single configured grant can be activated via a DCI, and multiple configured grants can be deactivated/released simultaneously via a DCI.

A UL cancellation indication (“ULCI”) is an indication sent in a group common Physical Downlink Control Channel (“PDCCH”) (DCI format 2_4) for each serving cell and the indication indicates a set of time-frequency resources wherein the UE should be muted.

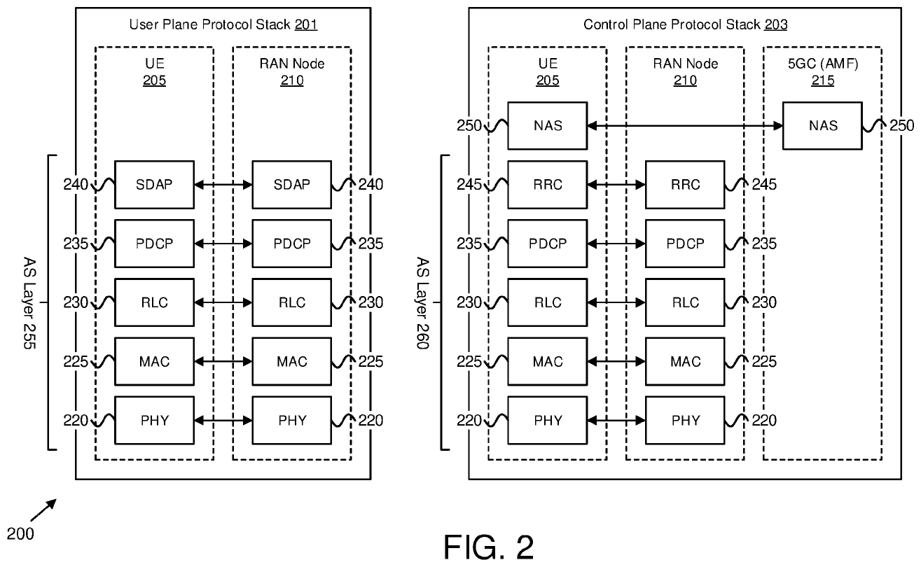

FIG. 2 depicts a NR protocol stack 200, according to embodiments of the disclosure. While FIG. 2 shows a UE 205, a RAN node 210 (e.g., a gNB) and an AMF 215 in a 5G core network (“5GC”), these are representative of a set of remote units 105 interacting with a base unit 121 and a mobile core network 140. As depicted, the NR protocol stack 200 comprises a User Plane protocol stack 201 and a Control Plane protocol stack 203. The User Plane protocol stack 201 includes the physical (“PHY”) layer 220, the Medium Access Control (“MAC”) sublayer 225, the Radio Link Control (“RLC”) sublayer 230, a Packet Data Convergence Protocol (“PDCP”) sublayer 235, and Service Data Adaptation Protocol (“SDAP”) layer 240. The Control Plane protocol stack 203 includes a PHY layer 220, a MAC sublayer 225, an RLC sublayer 230, and a PDCP sublayer 235. The Control Plane protocol stack 203 also includes a Radio Resource Control (“RRC”) layer 245 and a Non-Access Stratum (“NAS”) layer 250.

The AS layer 255 (also referred to as “AS protocol stack”) for the User Plane protocol stack 201 consists of at least the SDAP sublayer 240, PDCP sublayer 235, RLC sublayer 230 and the MAC sublayer 225, and the PHY layer 220. The AS layer 260 for the Control Plane protocol stack 203 consists of at least the RRC sublayer 245, PDCP sublayer 235, RLC sublayer 230, the MAC sublayer 225, and the PHY layer 220. The Layer-1 (“L1”) comprises the PHY layer 220. The Layer-2 (“L2”) is split into the SDAP sublayer 240, PDCP sublayer 235, RLC sublayer 230, and the MAC sublayer 225. The Layer-3 (“L3”) includes the RRC sublayer 245 and the NAS layer 250 for the control plane and includes, e.g., an Internet Protocol (“IP”) layer or PDU Layer (not depicted) for the user plane. L1 and L2 are referred to as “lower layers,” while L3 and above (e.g., transport layer, application layer) are referred to as “higher layers” or “upper layers.”

The PHY layer 220 offers transport channels to the MAC sublayer 225. The MAC sublayer 225 offers logical channels to the RLC sublayer 230. The RLC sublayer 230 offers RLC channels to the PDCP sublayer 235. The PDCP sublayer 235 offers radio bearers to the SDAP sublayer 240 and/or RRC layer 245. The SDAP sublayer 240 maps QoS flows within a PDU Session to a corresponding Data Radio Bearer over the air interface and the SDAP sublayer 240 interfaces the QoS flows to the 5GC (e.g., to user plane function, UPF). The RRC layer 245 provides for the addition, modification, and release of Carrier Aggregation (“CA”) and/or Dual Connectivity (“DC”). The RRC layer 245 also manages the establishment, configuration, maintenance, and release of Signaling Radio Bearers (“SRBs”) and Data Radio Bearers (“DRBs”). In certain embodiments, a RRC entity functions for detection of and recovery from radio link failure.

The NAS layer 250 is between the UE 205 and the AMF 215 in the 5GC. NAS messages are passed transparently through the RAN. The NAS layer 250 is used to manage the establishment of communication sessions and for maintaining continuous communications with the UE 205 as it moves between different cells of the RAN. In contrast, the AS layers 255 and 260 are between the UE 205 and the RAN (i.e., RAN node 210) and carry information over the wireless portion of the network. While not depicted in FIG. 2, the IP layer exists above the NAS layer 250, a transport layer exists above the IP layer, and an application layer exists above the transport layer.

The MAC layer 225 is the lowest sublayer in the Layer-2 architecture of the NR protocol stack. Its connection to the PHY layer 220 below is through transport channels, and the connection to the RLC layer 230 above is through logical channels. The MAC layer 225 therefore performs multiplexing and demultiplexing between logical channels and transport channels: the MAC layer 225 in the transmitting side constructs MAC PDUs, known as transport blocks, from MAC Service Data Units (“SDUs”) received through logical channels, and the MAC layer 225 in the receiving side recovers MAC SDUs from MAC PDUs received through transport channels.

The MAC layer 225 provides a data transfer service for the RLC layer 230 through logical channels, which are either control logical channels which carry control data (e.g., RRC signaling) or traffic logical channels which carry user plane data. On the other hand, the data from the MAC layer 225 is exchanged with the PHY layer 220 through transport channels, which are classified as downlink or uplink. Data is multiplexed into transport channels depending on how it is transmitted over the air.

The PHY layer 220 is responsible for the actual transmission of data and control information via the air interface, i.e., the PHY Layer 220 carries all information from the MAC transport channels over the air interface on the transmission side. Some of the important functions performed by the PHY layer 220 include coding and modulation, link adaptation (e.g., Adaptive Modulation and Coding (“AMC”)), power control, cell search and random access (for initial synchronization and handover purposes) and other measurements (inside the 3GPP system (i.e., NR and/or LTE system) and between systems) for the RRC layer 245. The PHY layer 220 performs transmissions based on transmission parameters, such as the modulation scheme, the coding rate (i.e., the modulation and coding scheme (“MCS”)), the number of physical resource blocks, etc.

According to embodiments of a first solution, a Frame Based Equipment (“FBE”) device can be configured with more than one fixed frame period for semi-static channel access, wherein each of the Fixed Frame Period (“FFP”) is associated with a specific beam to allow transmissions on a corresponding beam within that FFP from the initiating device to responding device(s).

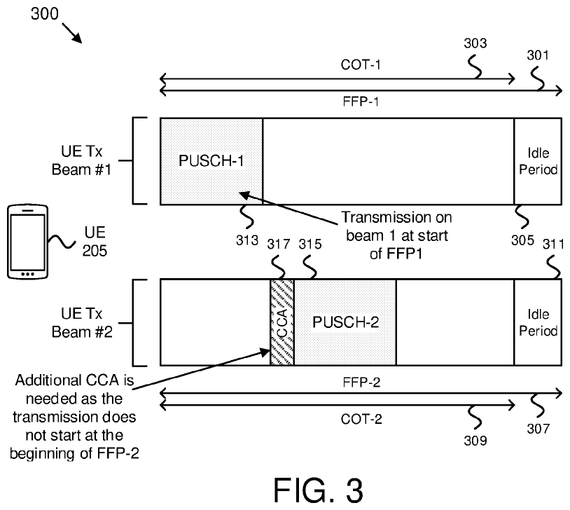

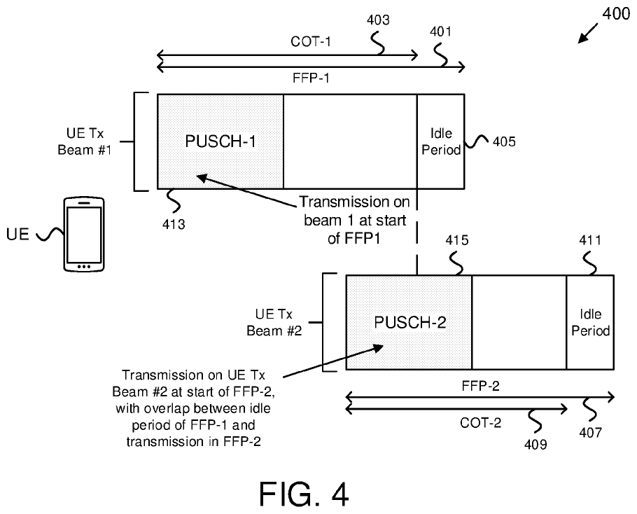

In one implementation, the FFP configuration for each of the FFPs can be same, i.e., the same starting offset and same period length is applied to each of the FFP. In the FFP configuration, also the corresponding Tx beam (e.g., Tx Quasi-Co-Location (“QCL”) assumption) for the initiating device is included to identify which FFP is associated with which beam. In some embodiments, for semi-static channel access mode, the start of FFP for a UE-initiated COT may be different from the start of FFP for a gNB-initiated COT. An illustration for 2 FFPs associated with 2 different Tx beams, but same offset and period is shown in FIG. 3.

FIG. 3 depicts a communication scheme 300 with two FFPs associated with two beams and same FFP configurations, according to embodiments of the disclosure. The communication scheme 300 involves a UE 205, which may be configured by a gNB or other access network entity. In the depicted embodiment, the UE 205 is configured with a first FFP 301 (depicted as “FFP-1”) comprising a first COT 303 (depicted as “COT-1”) and an idle period 305. Note that the first FFP 301 is associated with a first transmit beam of the UE (depicted as “UE Tx Beam #1).

The UE 205 is also configured with a second FFP 307 (depicted as “FFP-2”) comprising a second COT 309 (depicted as “COT-2”) and an idle period 311. Note that the second FFP 307 is associated with a second (different) transmit beam of the UE (depicted as “UE Tx Beam #2). It is assumed the first and second UE transmit beams are non-adjacent and spatially diverse, that is, that the directions of the first and second UE transmit beams sufficiently diverse so that a transmission on the first UE transmit beam would result in at most an insignificant amount of interference for a transmission on the second UE transmit beam.

As noted above, because the FFP configuration for each of the first FFP 301 and the second FFP 307 are the same, these FFPs are aligned in time such that the starting offset is the same for both the first FFP 301 and the second FFP 307 and the same period length is applied to the first FFP 301 and the second FFP 307. Also, the idle periods 305, 311 at the end of the first FFP 301 and the second FFP 307 are aligned in time (i.e., the idle periods 305, 311 occur at the same time).

When initiating the first COT 303 and the second COT 309, the UE 205 performs a CCA corresponding to at least the first and second UE transmit beams. As depicted, at the start of the first COT 303, the UE 205 performs a first uplink/PUSCH transmission 313 (depicted as “PUSCH-1”) in the first FFP 301 associated with first UE transmit beam. Somewhere in the middle of the second COT 309, the UE 205 also performs a second uplink/PUSCH transmission 315 (depicted as “PUSCH-2”) in the second FFP 307 associated with second UE transmit beam.

However, because the second uplink/PUSCH transmission 315 in the second FFP 307 associated with the second UE transmit beam is in the middle of the second COT 309, an additional CCA 317 may be needed just before the second uplink/PUSCH transmission 315. In one embodiment, this additional CCA 317 is required if a time gap between the beginning of a respective COT and the respective transmission is greater than (or equal to) a predetermined amount of time.

Although in FIG. 3, Time Division Multiplexing (“TDM”) transmission on different beams is illustrated, however, Spatial Division Multiplexing (“SDM”) or Frequency Division Multiplexing (“FDM”) transmissions in different beams can also be possible using different FFPs, where the transmissions start at same time on different beams (and FFPs).

In another implementation of the first solution, the FFP configuration for each of the FFPs associated with different beams can be different in terms of starting offset, period length, or a combination thereof. An illustration for two FFPs associated with two different UE Tx beams, having different starting offsets and different periods is shown in FIG. 4.

FIG. 4 depicts a communication scheme 400 with two FFPs associated with two beams and different FFP configurations, according to embodiments of the disclosure. The communication scheme 400 involves a UE 205, which may be configured by a gNB or other access network entity. In the depicted embodiment, the UE 205 is configured with a first FFP 401 (depicted as “FFP-1”) comprising a first COT 403 (depicted as “COT-1”) and an idle period 405. Note that the first FFP 401 is associated with a first transmit beam of the UE (depicted as “UE Tx Beam #1).

The UE 205 is also configured with a second FFP 407 (depicted as “FFP-2”) comprising a second COT 409 (depicted as “COT-2”) and an idle period 411. Note that the second FFP 407 is associated with a second (different) transmit beam of the UE (depicted as “UE Tx Beam #2). It is assumed the first and second UE transmit beams are non-adjacent and spatially diverse, that is, that the directions of the first and second UE transmit beams sufficiently diverse so that a transmission on the first UE transmit beam would result in, at most, an insignificant amount of interference for a transmission on the second UE transmit beam.

As noted above, because the FFP configuration for the first FFP 401 and the second FFP 407 are not the same, these FFPs are not aligned in time. Therefore, the first FFP 401 may have a different starting offset than the second FFP 407 and/or the first FFP 401 may have a different period length than the second FFP 407. Consequently, the idle periods 405, 411 at the end of first FFP 401 and the second FFP 407 are not aligned in time (i.e., the idle periods 405, 411 do not occur at the same time). While not shown in FIG. 4, the UE 205 may perform LBT/CCA corresponding to at least the first UE transmit beam when initiating the first COT 403 and may perform LBT/CCA corresponding to at least the second UE transmit beam when initiating the second COT 409.

As depicted, at the start of the first COT 403, the UE 205 performs a first uplink/PUSCH transmission 413 (depicted as “PUSCH-1”) in the first FFP 401 associated with first UE transmit beam. Moreover, while the idle period 405 for the first FFP 401 is ongoing, the UE 205 also performs a second uplink/PUSCH transmission 415 (depicted as “PUSCH-2”) in the second FFP 407 associated with second UE transmit beam. Because the second uplink/PUSCH transmission 415 is on a UE Tx Beam that does not belong to the first FFP 401, the idle period 405 associated with the first FFP 401 is still respected. Accordingly, when multiple FFPs are associated with multiple beams, then during the idle period of one FFP, there can be transmission on another FFP associated with different beam.

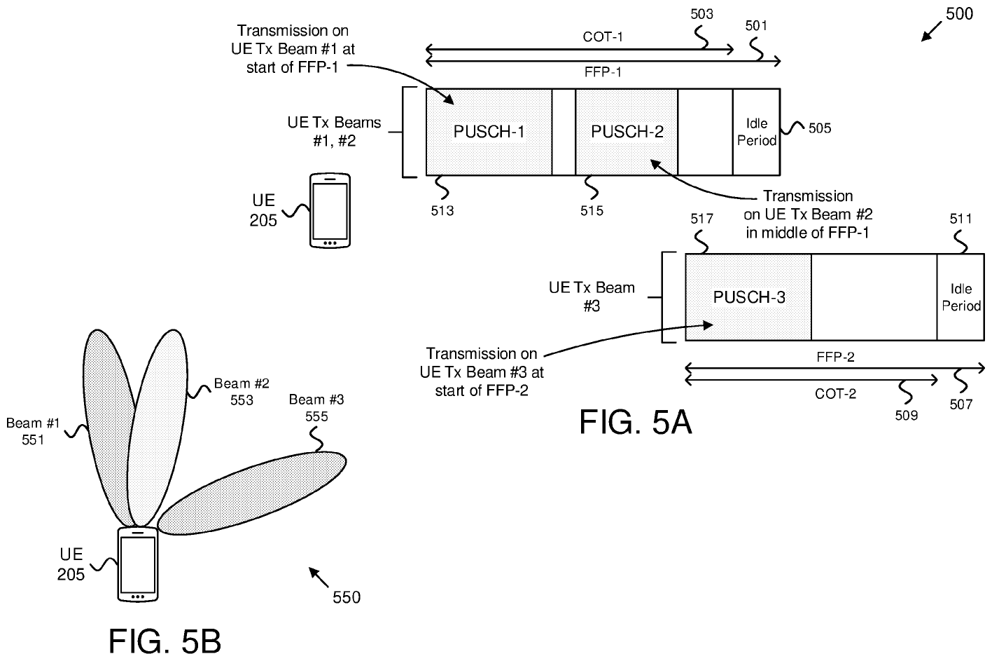

FIG. 5A depicts a communication scheme 500 with two FFPs associated with different beams, where one FFP is associated with multiple beams, according to embodiments of the disclosure. In some embodiments, one FFP can be associated with more than one beam to allow transmission on corresponding beams within the same FFP. The communication scheme 500 involves a UE 205, which may be configured by a gNB or other access network entity.

In the depicted embodiment, the UE 205 is configured with a first FFP 501 (depicted as “FFP-1”) comprising a first COT 503 (depicted as “COT-1”) and an idle period 505. Note that the first FFP 501 is associated with both a first transmit beam of the UE (depicted as “UE Tx Beam #1) and a second transmit beam of the UE (depicted as “UE Tx Beam #2). The UE 205 is also configured with a second FFP 507 (depicted as “FFP-2”) comprising a second COT 509 (depicted as “COT-2”) and an idle period 511. Note that the second FFP 507 is associated with a third (different) transmit beam of the UE (depicted as “UE Tx Beam #3).

Note that the FFP configuration for the first FFP 501 and the second FFP 507 are not the same and these FFPs are not aligned in time. Therefore, the first FFP 501 may have a different starting offset than the second FFP 507 and/or the first FFP 501 may have a different period length than the second FFP 507. Consequently, the idle periods 505, 511 at the end of first FFP 501 and the second FFP 507 are not aligned in time (i.e., the idle periods 505, 511 do not occur at the same time). Further, during the idle period of one FFP, there can be transmission on another FFP associated with different beam.

FIG. 5B depicts a beam arrangement 550 of the UE 205, according to embodiments of the disclosure. Here, the UE 205 uses a first beam 551 (depicted as Beam #1) and a second beam 553 (depicted as Beam #2) that is substantially adjacent to the first beam 551. Note here, that the first beam 551 and second beam 553 are neighboring beams and are not spatially diverse, thus a transmission on the first UE transmit beam would create significant amount of interference for a transmission on the second UE transmit beam. Additionally, the UE 205 uses a third beam 555 (depicted as “Beam #3”) that is a non-adjacent (disjointed) beam. The third beam 555 is spatially diverse from the first beam 551 and second beam 553.

Turning again to FIG. 5A, the UE 205 is scheduled to transmit on three different beams (i.e., UE Tx Beam #1, UE Tx Beam #2 and UE Tx Beam #3), where the first FFP 501 is with both the first and second UE transmit beams and the second FFP 507 is associated with the third UE transmit beam. Because the first and second UE transmit beams are adjacent beams, the UE 205 cannot transmit on the first and second UE transmit beams during the same time and on the same frequency. In various embodiments, the first UE transmit beam corresponds to the first beam 551, the second UE transmit beam is the second beam 553, and the third UE transmit beam is the third beam 555.

As depicted, at the start of the first COT 503, the UE 205 performs a first uplink/PUSCH transmission 513 (depicted as “PUSCH-1”) in the first FFP 501 associated with first UE transmit beam. Moreover, during the middle of the first COT 503, the UE 205 performs a second uplink/PUSCH transmission 515 (depicted as “PUSCH-2”) in the first FFP 501 associated with first UE transmit beam. Further, the UE 205 also performs a third uplink/PUSCH transmission 517 (depicted as “PUSCH-3”) in the second FFP 507 associated with second UE transmit beam. Note that the third uplink/PUSCH transmission 517 may be performed while the idle period 505 for the first FFP 501 is ongoing, similar to the situation described above.

In various embodiments of the first solution, a communication device (e.g., UE) may be configured with one common FFP (i.e., associated with all beams) and may be additionally configured with one or more beam-specific FFPs. In such embodiments, prior to transmitting on any configured FFP, a CCA is performed for all beams (in sequential manner or parallel manner or omni-directional manner) for transmission using the common FFP. If the channel is clear, then the communication device is permitted and if the channel is not clear, then the communication device may be required to perform CCA for FFPs associated with specific-beams.

In an implementation, a User Equipment (“UE”) receives information of a plurality of associated FFP configurations for which the UE can initiate a plurality of FFPs concurrently and can perform, during an idle period of a first FFP of the plurality of FFPs, a transmission associated with a second FFP of the plurality of FFPs. For example, a network entity (e.g., gNB) configures the UE with a first FFP configuration with a first UE transmit beam (or a first Sounding Reference Signal (“SRS”) resource/resource set or a first TCI state) and a second FFP configuration with a second UE transmit beam (or a second SRS resource/resource set or a second TCI state), where the first UE transmit beam (or a first gNB receive beam corresponding to the first UE transmit beam) and the second UE transmit beam (or a second gNB receive beam corresponding to the second UE transmit beam) are spatially separated and cause less or no interference on each other.

The following are some exemplary applications related to the first solution:

In certain embodiments, a communication device (e.g., UE) can be configured with more than one FFP for semi-static channel access, where each FFP is associated with a set of specific beams to allow transmissions on corresponding beams within that FFP from the initiating device to responding device(s).

In one example, the set of specific beams may be configured using RRC signaling for each FFP configuration. In another example, each FFP configuration is associated with a reference beam (e.g., indicated as part of the FFP configuration), and the set of specific beams are derived from the reference beam.

In certain embodiments, the FFP periodicities of the multiple configured FFPs are multiple of each other or a factor of each other. Note that, for semi-static channel access mode, the periodicity for UE-initiated COT may be different from the FFP periodicity for gNB-initiated COT.

In certain embodiments, a UE may initiate (i.e., acquire) a Channel Occupancy Time (“COT”) by sensing the channel by at most ‘X’ beams and transmitting an Uplink (“UL”) transmission with a beam associated to one of the ‘X’ beams. Here, ‘X’ is reported as a UE capability.

In certain embodiments, a UE may indicate whether a UE-acquired COT is based on non-beam-specific LBT (e.g., based on a common FFP) or if the UE-acquired COT is based on beam-specific LBT (e.g., based on a beam-specific FFP). Such technique could help the network (e.g., gNB) in scheduling UL transmissions within that UE-acquired FFP. Note that a common FFP may have different configuration/channel access parameters (e.g., in terms of LBT category, LBT gap, etc.) compared to those of a respective beam-specific FFP.

In certain embodiments, if a UE initiates an FFP with a first beam, then the UE is not expected to change the beam within that FFP for UL transmissions corresponding to UE-initiated FFP.

In certain embodiments, the UE is not expected/required to perform CCA/LBT operation if the gap between two UL transmission bursts is smaller than a first threshold (e.g., 16 micro-seconds) if both UL transmission bursts are associated with the same beam. If the two UL transmission bursts are associated with two different beams, an LBT/CCA is required, or alternatively if the gap between the two UL transmission bursts with different beams is smaller than a second threshold (e.g., which is shorter than the first threshold) no LBT is needed.

In certain embodiments, the UE is configured with a set of UL beams that are allowed in a UE-initiated COT wherein the UE had performed directional LBT and had initiated the COT using an UL transmission of a first UL beam. The set of beams are identified/linked to the first UL beam.

In some embodiments, gNB-to-UE COT sharing in semi-static channel access mode is supported for beam-based FFPs. According to embodiments of a second solution, an access network entity (e.g., gNB) initiates a FFP that may be associated with one or multiple beams. Further, the access network entity indicates to other devices (i.e., responding devices) whether the initiated FFP can be used for transmission by the responding devices using one or multiple beams.

In one implementation, when a gNB transmits a scheduling Downlink Control Information (“DCI”) to a UE in an FFP associated with the corresponding Tx beam(s), then the UE can assume to utilize the same gNB-initiated FFP with the same beam that is used by UE to receive the PDCCH (scheduling DCI) from the gNB, assuming that UE is capable of beam correspondence. If UE is not capable of beam correspondence, then UE is expected to initiate its own FFP associated with the indicated/configured Tx beam(s) for UL transmission(s).

As used herein, the following are defined as Tx/Rx beam correspondence at a TRP and UE:

Tx/Rx beam correspondence at a respective TRP holds if at least one of the following is satisfied:
The TRP is able to determine a TRP Rx beam for the uplink reception based on the UE's downlink measurement on the TRP's one or more Tx beams; and/or
The TRP is able to determine a TRP Tx beam for the downlink transmission based on the TRP's uplink measurement on the TRP's one or more Rx beams.

Tx/Rx beam correspondence at a respective UE holds if at least one of the following is satisfied:
The UE is able to determine a UE Tx beam for the uplink transmission based on the UE's downlink measurement on the UE's one or more Rx beams; and/or
The UE is able to determine a UE Rx beam for the downlink reception based on the TRP's indication based on uplink measurement on the UE's one or more Tx beams; and/or
A capability indication of UE beam correspondence related information to the TRP is supported.

In some embodiments of the second solution, respective FFPs configured for gNB are associated with certain UE Tx beam(s) corresponding to UL transmissions. Accordingly, a respective UE is allowed to use a particular gNB-initiated, beam-specific FFP only if the scheduled/configured UL transmissions are scheduled with one of the associated UE Tx beam(s).

In one implementation of the above, an association between the UL TCI states (e.g., QCL assumptions with at least on type-D QCL) and corresponding gNB-initiated FFP(s) is semi-statically configured (e.g., by RRC signaling). In this case, when the gNB transmits a scheduling DCI to a UE in an FFP, then the UE can utilize the same gNB-initiated FFP if the indicated TCI state (with QCL type-D assumption) is associated with that gNB-initiated FFP. Otherwise, if the indicated TCI state (with QCL type-D assumption) is not associated with that gNB-initiated FFP, then the UE is expected to initiate its own FFP associated with the indicated/configured TCI state (with QCL type-D assumption) for UL transmission(s).

Likewise, the second solution is also applicable for sharing of a gNB-initiated FFP with Configured Grant (“CG”) transmissions, where a CG resource is associated with one or multiple beams and the corresponding beam is associated with a gNB-initiated FFP.

In case of Type 2 CG (i.e., where a CG configuration is received via RRC signaling, but the corresponding CG resource is activated by DCI), when the activating DCI is transmitted by gNB using a gNB-initiated FFP, then the UE is allowed to transmit the corresponding CG UL transmission using the same FFP, if the configured beam for UL is associated with that FFP. Otherwise, UE will initiate its own FFP associated with corresponding beam for the corresponding CG UL transmission.

In some embodiments of the second solution, a respective gNB may send group-common DCI (“GC-DCI”) using its own gNB-initiated FFP to a group of UEs. Here, the corresponding UEs in the group of UEs are expected to utilize the same gNB-initiated FFP for their UL transmissions.

In alternate embodiments, a gNB may indicate an association between a UL QCL assumption and gNB-initiated FFPs, such that a respective UE can utilize the corresponding gNB-initiated FFP if the corresponding UL QCL assumption is indicated/configured.

In an implementation of the second solution, a UE may receive association information of DL and UL TCI states. Alternatively, the UE may receive association information of DL TCI states and UL SRS resources/resource sets. In this implementation, when detecting a DL burst of a second TCI state in the gNB-initiated FFP, the UE can perform an UL transmission associated with a first UL TCI state/SRS resource in a gNB-initiated FFP, where the second TCI state is associated with the first UL TCI state/SRS resource.

The following are some example applications related to the second solution:

According to example Method-A, a respective UE determines whether a configured UL transmission that is aligned with a UE FFP boundary (i.e., the configured UL resource starts at most a predefined gap duration (including gap duration of zero/no-gap) after the UE FFP begins, and ends before the idle period of that UE FFP) is based on UE-initiated COT or sharing a gNB-initiated COT according to the following procedure:
If the configured UL transmission is confined within a gNB FFP (i.e., associated with a set of beams) before the idle period of that gNB FFP, and the UE has already determined that gNB is initiated that gNB FFP, and the configured UL transmission is associated with a beam corresponding to the set of beams, UE assumes that the configured UL transmission corresponds to gNB-initiated COT. Otherwise, if the configured UL transmission is not confined within the gNB FFP, then the UE assumes that the configured UL transmission corresponds to UE-initiated COT. As used herein, a “UE FFP” refers to a respective FFP that the UE can initiate, and a “gNB FFP” refers to a respective FFP that the gNB can initiate.

In certain embodiments, if a respective UE is configured with a set of FFP configurations for UE-initiated COT/FFP, where each FFP configuration is associated with a set of UE beams, for a configured UL transmission, then the UE performs the following Steps A-E:
Step A: The UE determines if the configured UL transmission is aligned with a 1^{st} subset of the UE FFPs of the set of FFPs (i.e., the configured UL transmission starts at the beginning of one or more FFPs of the 1^{st} subset of the UE FFPs).
Step B: In response to determining the configured UL transmission is aligned with only one FFP of the set of UE FFPs, the UE operates as example method A. Otherwise, in response to determining the configured UL transmission is aligned with more than one FFP of the set of UE FFPs (the 1^{st} subset of the UE FFPs), the UE operates according to the followings sub-steps:
Sub-step 1: The UE determines the configured UL transmission ends before the idle period of which FFPs of the 1^{st} subset of FFPs.
Sub-step 2: In response to determining the configured UL transmission ends before the idle period of ‘m’ FFPs:
For ‘m’=0, the UE checks if the configured UL transmission can be associated with a gNB-FFP similar to example Method-A (above), if not the UE would not start transmitting the configured UL transmission.
For ‘m’=1, the UE operates as example Method-A.
For ‘m’>1, the UE determines if for any of the ‘m’ FFPs, the UE has already initiated an FFP/COT.
Sub-step 3: In response to determining the UE has already initiated an FFP/COT for ‘n’<=‘m’ FFPs, then the UE determines if the configured UL transmission is confined within a gNB FFP (associated with a set of beams) before the idle period of that gNB FFP. If so, and if the configured UL transmission is associated with a beam corresponding to the set of beams, then the UE assumes that the configured UL transmission corresponds to gNB-initiated COT. Otherwise, the UE assumes that the configured UL transmission corresponds to UE-initiated COT (UE FFP) that is associated to the UL beam used for the configured UL transmission.
Step C: In response to determining that the configured UL transmission is not aligned with any UE FFPs of the UE FFPs of the set of FFPs, the UE performs the following sub- steps:
Sub-step 1: The UE determines if the UE has already initiated a first set of the UE FFPs.
Sub-step 2: If yes, then the UE assumes that the configured UL transmission corresponds to UE-initiated COT (UE FFP) that is associated to the UL beam used for the configured UL transmission.
Sub-step 3: If no, then the UE determines if the configured UL transmission is confined within a set of gNB FFPs before the idle periods of those gNB FFPs.
Sub-step 4: If yes, then the UE determines if the gNB has initiated a first set of gNB FFPs, then UE assumes that the configured UL transmission corresponds to the gNB-initiated COT/FFP that is associated to the UL beam used for the configured UL transmission.
Sub-step 5: If no, then the UE does not transmit the configured UL transmission.
Step D: For any remaining cases that the UE operation is not determined above, the UE would not be able to start transmission in that CG resource (would not perform the configured UL transmission).

The UE is not expected to be configured with more than one UE FFP configurations corresponding to a particular UL beam. The UE is not expected to be configured with more than one gNB FFP configurations corresponding to a particular UL beam.
Step E: Alternatively, if the UE has already determined that gNB has initiated a first set of gNB FFPs, and the UL beam used for the configured UL transmission corresponds to more than one initiated gNB FFP,
the UE indicates which gNB FFP UE assumes that the configured UL transmission corresponds to, or
the UE assumes that the configured UL transmission corresponds to a gNB FFP that has the lowest configuration index, or a gNB FFP that has the longest/shortest period among the gNB FFPs of the first set of gNB FFPs.

In certain embodiments, the gNB indicates (e.g., in a GC-DCI) the gNB-FFP configuration index if more than one gNB-FFP configurations associated to different/same beams are configured, or the UE can determine the gNB-FFP index based on a transmission from the gNB (e.g., transmission beam of the transmission). In an example, gNB may send a GC-DCI in a window starting at the beginning of a gNB-FFP.

In an example, the UE is not expected to be configured with a gNB-FFP configuration, such that no GC-DCI monitoring occasion exists in a window of time of a particular duration starting at the beginning of a gNB-FFP of the gNB FFP configuration. Alternatively, if the UE is not configured with a GC-DCI monitoring occasion in a window of time of a particular duration starting at the beginning of a gNB-FFP, the UE would not consider that gNB-FFP as a valid gNB FFP, and hence, assumes gNB-FFP is not initiated in that gNB-FFP.

In some embodiments, UE-to-gNB COT sharing in semi-static channel access mode is supported for beam-based FFPs. According to embodiments of a third solution, the UE may share a directional (i.e., beam-based) UE-initiated FFP with the gNB or another access network node. Here, the UE initiates beam specific FFP for transmission to another device (gNB or another UE or another network node) using specific beam(s). In certain embodiments, the gNB determines a COT in an FFP associated to a UE, that is initiated by the UE, if the gNB detects a UL transmission from the UE starting from the beginning of the FFP and ending before the idle period of the FFP. In certain embodiments, when the gNB determines a UE has initiated a COT in an FFP associated to the UE, the gNB can transmit within the FFP and before the idle period corresponding to the FFP.

In one implementation, although a UE may have detected that it may transmit on a gNB-initiated FFP that FFP may not be associated with the indicated/configured UL Tx beam. Therefore, UE may be required to initiate its own FFP corresponding to the beam. In case of UE-initiated beam specific FFP, gNB may share the FFP for transmission to the same UE, but only on certain beam(s) that may be allowed for transmission within that UE-initiated FFP. Either the UE could indicate which corresponding Tx beam(s) could be allowed for gNB transmission (in case of beam correspondence) or gNB could determine a priori to transmission.

Note that for Rel-17, conditions on the channel access procedures with respect to sensing duration and transmission gap for UE-initiated COT with UE-to-gNB COT sharing is similar as those for gNB-initiated COT and gNB-to-UE COT sharing in Rel-16 by exchanging UE and gNB roles.

According to embodiments of a fourth solution, the gNB transmits scheduling DCI to UE in one FFP associated with one beam, wherein the scheduled DL transmission can be associated with a different FFP. In this scenario, the scheduling DCI may be associated with one QCL assumption (beam), while the scheduled transmission maybe associated with a second QCL assumption (beam). Therefore, for example, one FFP for PDCCH and another FFP for Physical Downlink Shared Channel (“PDSCH”) can be initiated depending up on the corresponding beams.

In general, following combinations for cross FFP scheduling can be possible:
DCI in one gNB-initiated FFP and data transmission in UE-initiated FFP
DCI in one UE-initiated FFP and data transmission in gNB-initiated FFP
DCI in one UE-initiated FFP and data transmission in another UE-initiated FFP

Which of the FFPs are initiated in above combination can depend on the associated beams.

Regarding URLLC NR-U operation in NR Rel-17, if sensing is needed for semi-static channel access mode, it is performed immediately before the configured/scheduled transmission opportunity. For operation with semi-static channel access, the Rel-16 random starting offsets for Uplink (“UL”) configured grants with Full Bandwidth (“BW”) allocation when the UE initiates a COT, is not supported.

For semi-static channel access mode, the network may support using the transmission of any scheduled/configured UL channel/signal to initiate a COT by a UE in RRC_CONNECTED mode. In certain embodiments, a UE initiates a COT in an FFP associated with the UE, if the UE transmits a UL transmission burst starting at the beginning of the FFP and ending at any symbol before the FFP's idle period after a successful Clear Channel Assessment (“CCA”) of 9 μs immediately before the UL transmission burst.

In some embodiments, for semi-static channel access mode, the FFP parameters for UE-initiated COT may be provided to the UE by at least dedicated RRC signaling. In one embodiment, the FFP parameters for UE-initiated COT may be provided to the UE by SIB-1. In certain embodiments, the UE FFP periodicity is explicitly configured. In other embodiments, the UE FFP periodicity is implicitly determined based on other higher layer parameters.

In some embodiments, for semi-static channel access mode, a single FFP (periodicity and offset) is associated to an initiating device (gNB or UE) at a given time which may be used for the purpose of channel occupancy. The FFP configuration that is used for initiating channel occupancy purposes, is such that it shall not be changed for at least 200 ms. In certain embodiments, the network supports UE-to-gNB COT sharing in semi-static channel access mode with a gap >16 μs.

Accordingly, if a device X at a given time is initiating a COT, the applicable FFP for the device X is the FFP associated with X. If a device X at a given time is sharing a COT initiated by a device Y, the applicable FFP for the device X is the FFP associated with Y. Here, one of the devices X and Y is a UE and the other is its serving gNB.

In some embodiments, the gNB configures a UE to initiate semi-static Channel Occupancy (“CO”) in an unlicensed channel(s) only if the gNB configures the UE also with the higher layer parameters of the gNB's initiating semi-static CO in the same channel(s). In certain embodiments, a UE-initiated Frame Based Equipment (“FBE”) configuration is configured per serving cell.

In some embodiments, in semi-static channel access mode, FFP Period for UE-initiated COT is separately provided from FFP period for gNB-initiated COT. In one embodiment, any value for the period, shall be at least 1 ms and at most 10 ms.

In some embodiments, in semi-static channel access mode, a UE may be able to determine whether a scheduled UL transmission should be transmitted according to shared gNB COT or UE-initiated COT. In such embodiments, the UE may determine the initiator of a COT based on at least one of the following options:

Option 1: Introduce additional bit field in the scheduling Downlink Control Information (“DCI”); Option 2: Based on ChannelAccess-CPext field in DCI; Option 3: Based on a predetermined rule(s); Option 4: Based on RRC signaling; Option 5: Based on MAC Control Element (“CE”). Note that a scheduled UL transmission cannot be transmitted according to both shared gNB COT and UE-initiated COT.

In some embodiments, in semi-static channel access mode, when a configured UL transmission is aligned with a UE FFP boundary and ends before the idle period of that UE FFP associated to the UE, down-select one of the following options:

Option A: If the transmission is confined within a gNB FFP before the idle period of that gNB FFP, and the UE has already determined that gNB is initiated that gNB FFP, UE assumes that the configured UL transmission corresponds to gNB-initiated COT. Otherwise, UE assumes that the configured UL transmission corresponds to UE-initiated COT. Option B: The UE assumes that the configured UL transmission corresponds to UE-initiated COT. Option C: The UE assumption on whether the configured UL transmission is allowed to correspond to UE-initiated COT is based on gNB configuration.

When a configured UL transmission starts after a UE FFP boundary and ends before the idle period of that UE FFP associated to the UE, if the UE has already initiated the UE FFP, then UE assumes that the configured UL transmission corresponds to UE-initiated COT. Otherwise, If the transmission is confined within a gNB FFP before the idle period of that gNB FFP, and if the UE has already determined that gNB has initiated that gNB FFP, then UE assumes that the configured UL transmission corresponds to gNB-initiated COT. Note that a configured UL transmission cannot be transmitted according to both shared gNB COT and UE-initiated COT.

In some embodiments, in semi-static channel access mode, UE FFP periodicity is chosen from the following set of values in ms: {1, 2, 2.5, 4, 5, 10}. In certain embodiments, an FFP period for UE-initiated COT is configured as the same, integer multiple of, or inter-factor of the FFP period configured for gNB-initiated COT. In certain embodiments, the FFP period for UE-initiated COT may be configured independently from FFP period of gNB-initiated COT, if the UE indicates the corresponding capability. In certain embodiments, the FFP offset for UE-initiated COT is the starting point of first UE FFP relative to the radio frame X boundary. In various embodiments, the offset value range is 0≤offset<FFP period of UE-initiated COT.

In some embodiments, for semi-static channel access mode when a UE can operate as initiating device, the determination of whether a scheduled UL transmission is based on UE-initiated COT or sharing a gNB-initiated COT may be based on the content in the scheduling DCI. If absent, the determination may be based on the rules applied for configured UL transmissions is applied. In other embodiments, the determination may be based on the rules applied for a configured UL transmission.

In some embodiments, for semi-static channel access mode when a UE can operate as UE-initiated COT, the determination of whether a configured UL transmission that is aligned with a UE FFP boundary and ends before the idle period of that UE FFP, is based on UE-initiated COT or sharing a gNB-initiated COT is as follows: Option-1, if the transmission is confined within a gNB FFP before the idle period of that gNB FFP, and the UE has already determined that gNB is initiated that gNB FFP, UE assumes that the configured UL transmission corresponds to gNB-initiated COT. Otherwise, UE assumes that the configured UL transmission corresponds to UE-initiated COT. Option-2, the UE assumes that the configured UL transmission corresponds to UE-initiated COT.

In some embodiments, for semi-static channel access mode, sharing a UE-initiated COT through the gNB to other intra-cell UEs for UL transmissions, is not supported. In certain embodiments, a network may support explicit RRC configuration for the UE-FFP parameters including period and offset in RRC connected mode.

In some embodiments, for semi-static channel access mode, the offset value for configuration of a UE-FFP for a serving cell has a symbol level granularity. In certain embodiments, for semi-static channel access mode, in addition to the agreed set of period values for configuration of a UE-FFP for a serving cell, the network does not support any additional period value.

In some embodiments, for semi-static channel access mode, the starting point of first UE FFP for a serving cell is relative to the boundary of the radio frame of even index number. In some embodiments, for semi-static channel access mode, the gNB can schedule by a DCI UL transmission(s) in a later g-FFP that is different from the g-FFP that carries the scheduling DCI. In certain embodiments, the UL transmission can occur only if the corresponding channel access requirements are met.

In some embodiments, for semi-static channel access mode, the gNB can schedule by a DCI Downlink (“DL”) transmission(s) in a later g-FFP that is different from the g-FFP that carries the scheduling DCI. The DL transmission can occur only if the corresponding channel access requirements are met.

In some embodiments, the network supports one of the following options. Option 1: the network does not support Physical Uplink Shared Channel (“PUSCH”) repetition Type B based on NR Unlicensed (“NR-U”) Rel-16 Configured Grant (“CG”) for unlicensed band operation. Option 2: the network supports enhancements of PUSCH repetition Type B based on NR-U Rel-16 CG for unlicensed band operation.

Accordingly, in semi-static channel access mode, a UE as an initiating device, is allowed to transmit during the idle period of any FFP associated with the serving gNB if the UE transmission is based on UE-initiated COT. Note that the gNB may disallow UL transmission during symbols of the idle period by configuring them either as semi-static DL symbols, or indicating them as DL with Slot Format Indicator (“SFI”).

In some embodiments, both “CG-UCI based procedures” and “CG-DFI based procedures” are enabled or disabled for unlicensed using one RRC parameter, i.e., cg-RetransmissionTimer-r16. In other embodiments, “CG-UCI based procedures” and “CG-DFI based procedures” are independently enabled or disabled for unlicensed using respective RRC parameter, i.e., new parameter X and cg-RetransmissionTimer-r16, respectively. In certain embodiments if cg-RetransmissionTimer-r16 is configured, “CG-UCI based procedures” should also be enabled by X.

Note that procedures based on Configured Grant Uplink Control Information (“CG-UCI”) rely on UE including CG-UCI in CG PUSCH at least as in Rel-16 where the values of the respective fields of CG-UCI are decided by UE. Note that procedures based on Configured Grant Downlink Feedback Information (“CG-DFI”) rely on automatic re-transmission on CG configuration and reception of CG-DFI in DCI for re-transmissions.

In some embodiments, for semi-static channel access mode when a UE can operate as UE-initiated COT, to determine whether a configured UL transmission that is aligned with a UE FFP boundary and ends before the idle period of that UE FFP, is based on UE-initiated COT or sharing a gNB-initiated COT, if the transmission is confined within a gNB FFP before the idle period of that gNB FFP, and the UE has already determined that gNB is initiated that gNB FFP, UE assumes that the configured UL transmission corresponds to gNB-initiated COT. Otherwise, UE assumes that the configured UL transmission corresponds to UE-initiated COT. Alternatively, the UE may assume that the configured UL transmission corresponds to UE-initiated COT.

Regarding QCL/TCI framework in NR, in current NR, QCL/TCI framework is specified to indicate the beams to the UE for receiving DL transmissions from the gNB. Furthermore, in Rel-17, discussions are on-going on how directional sensing will be done and if and how the sensing beams need to be associated with transmission beams. However, there is not discussion about semi-static channel access with directional LBT.

Regarding antenna ports and quasi co-location (“QCL”), the UE may be configured with a list of up to ‘M’ TCI-State configurations within the higher layer parameter PDSCH-Config to decode Physical Downlink Shared Channel (“PDSCH”) according to a detected Physical Downlink Control Channel (“PDCCH”) with DCI intended for the UE and the given serving cell, where M depends on the UE capability maxNumberConfiguredTCIstatesPerCC. Each TCI-State contains parameters for configuring a quasi-co-location relationship between one or two downlink reference signals and the Demodulation Reference Signal (“DM-RS”) ports of the PDSCH, the DM-RS port of PDCCH or the Channel State Information Reference Signal (“CSI-RS”) port(s) of a CSI-RS resource. The quasi co-location relationship is configured by the higher layer parameter qcl-Type1 for the first DL Reference Signal (“RS”), and qcl-Type2 for the second DL RS (if configured).

For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values:
‘typeA’: {Doppler shift, Doppler spread, average delay, delay spread}
‘typeB’: {Doppler shift, Doppler spread}
‘typeC’: {Doppler shift, average delay}
‘typeD’: {Spatial Rx parameter}

The UE receives an activation command, e.g., as described in clause 6.1.3.14 of 3GPP TS 38.321, used to map up to 8 TCI states to the codepoints of the DCI field ‘Transmission Configuration Indication’ in one CC/DL Bandwidth Part (“BWP”) or in a set of CCs/DL BWPs, respectively. When a set of TCI state IDs are activated for a set of CCs/DL BWPs, where the applicable list of Component Carriers (“CCs”) is determined by indicated Component Carrier (“CC”) in the activation command, the same set of Transmission Configuration Indicator (“TCI”) state IDs are applied for all DL BWPs in the indicated CCs.

When a UE supports two TCI states in a codepoint of the DCI field ‘Transmission Configuration Indication’ the UE may receive an activation command, e.g., as described in clause 6.1.3.24 of 3GPP TS 38.321, the activation command is used to map up to 8 combinations of one or two TCI states to the codepoints of the DCI field ‘Transmission Configuration Indication’. The UE is not expected to receive more than 8 TCI states in the activation command.

When the DCI field ‘Transmission Configuration Indication’ is present in DCI format 1_2 and when the number of codepoints S in the DCI field ‘Transmission Configuration Indication’ of DCI format 1_2 is smaller than the number of TCI codepoints that are activated by the activation command, e.g., as described in clause 6.1.3.14 and 6.1.3.24 of 3GPP TS 38.321, only the first S activated codepoints are applied for DCI format 1_2.

When the UE would transmit a Physical Uplink Control Channel (“PUCCH”) with Hybrid Automatic Repeat Request-Acknowledgement (“HARQ-ACK”) information in slot n corresponding to the PDSCH carrying the activation command, the indicated mapping between TCI states and codepoints of the DCI field ‘Transmission Configuration Indication’ should be applied starting from the first slot that is after slot n+3Nₛₗₒₜ^{subframe,μ} where μ is the Sub Carrier Spacing (“SCS”) configuration for the PUCCH.

If tci-PresentInDCI is set to ‘enabled’ or tci-PresentDCI-1-2 is configured for the Control Resource Set (“CORESET”) scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command, the UE may assume that the DM-RS ports of PDSCH of a serving cell are quasi co-located with the Synchronization Signal/Physical Broadcast Channel (“SS/PBCH”) block determined in the initial access procedure with respect to qcl-Type set to ‘typeA’, and when applicable, also with respect to qcl-Type set to ‘typeD’.

If a UE is configured with the higher layer parameter tci-PresentInDCI that is set as ‘enabled’ for the CORESET scheduling the PDSCH, the UE assumes that the TCI field is present in the DCI format 1_1 of the PDCCH transmitted on the CORESET. If a UE is configured with the higher layer parameter tci-PresentDCI-1-2 for the CORESET scheduling the PDSCH, the UE assumes that the TCI field with a DCI field size indicated by tci-PresentDCI-1-2 is present in the DCI format 1_2 of the PDCCH transmitted on the CORESET.

If the PDSCH is scheduled by a DCI format not having the TCI field present, and the time offset between the reception of the DL DCI and the corresponding PDSCH of a serving cell is equal to or greater than a threshold timeDurationForQCL if applicable, where the threshold is based on reported UE capability (see, e.g., 3GPP TS 38.306), for determining PDSCH antenna port quasi co-location, the UE assumes that the TCI state or the QCL assumption for the PDSCH is identical to the TCI state or QCL assumption whichever is applied for the CORESET used for the PDCCH transmission within the active BWP of the serving cell.

If the PDSCH is scheduled by a DCI format having the TCI field present, the TCI field in DCI in the scheduling component carrier points to the activated TCI states in the scheduled component carrier or DL BWP, the UE shall use the TCI-State according to the value of the ‘Transmission Configuration Indication’ field in the detected PDCCH with DCI for determining PDSCH antenna port quasi co-location. The UE may assume that the DM-RS ports of PDSCH of a serving cell are quasi co-located with the RS(s) in the TCI state with respect to the QCL type parameter(s) given by the indicated TCI state if the time offset between the reception of the DL DCI and the corresponding PDSCH is equal to or greater than a threshold time DurationForQCL, where the threshold is based on reported UE capability (see, e.g., 3GPP TS 38.306).

When the UE is configured with a single slot PDSCH, the indicated TCI state

should be based on the activated TCI states in the slot with the scheduled PDSCH. When the UE is configured with a multi-slot PDSCH, the indicated TCI state should be based on the activated TCI states in the first slot with the scheduled PDSCH, and UE shall expect the activated TCI states are the same across the slots with the scheduled PDSCH. When the UE is configured with CORESET associated with a search space set for cross-carrier scheduling and the UE is not configured with enableDefaultBeamForCCS, the UE expects tci-PresentInDCI is set as ‘enabled’ or tci-PresentDCI-1-2 is configured for the CORESET, and if one or more of the TCI states configured for the serving cell scheduled by the search space set contains qcl-Type set to ‘typeD’, the UE expects the time offset between the reception of the detected PDCCH in the search space set and the corresponding PDSCH is larger than or equal to the threshold timeDurationForQCL.

Independent of the configuration of tei-PresentInDCI and tei-PresentDCI-1-2 in RRC connected mode, if the offset between the reception of the DL DCI and the corresponding PDSCH is less than the threshold timeDurationForQCL and at least one configured TCI state for the serving cell of scheduled PDSCH contains qcl-Type set to ‘typeD’.

The UE may assume that the DM-RS ports of PDSCH of a serving cell are quasi co-located with the RS(s) with respect to the QCL parameter(s) used for PDCCH quasi co-location indication of the CORESET associated with a monitored search space with the lowest controlResourceSetId in the latest slot in which one or more CORESETs within the active BWP of the serving cell are monitored by the UE. In this case, if the qcl-Type is set to ‘typeD’ of the PDSCH DM-RS is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers).

If a UE is configured with enableDefaultTCIStatePerCoresetPoolIndex and the UE is configured by higher layer parameter PDCCH-Config that contains two different values of coresetPoolIndex in different ControlResourceSets.

The UE may assume that the DM-RS ports of PDSCH associated with a value of coresetPoolIndex of a serving cell are quasi co-located with the RS(s) with respect to the QCL parameter(s) used for PDCCH quasi co-location indication of the CORESET associated with a monitored search space with the lowest controlResourceSetId among CORESETs, which are configured with the same value of coresetPoolIndex as the PDCCH scheduling that PDSCH, in the latest slot in which one or more CORESETs associated with the same value of coresetPoolIndex as the PDCCH scheduling that PDSCH within the active BWP of the serving cell are monitored by the UE. In this case, if the ‘QCL-TypeD’ of the PDSCH DM-RS is different from that of the PDCCH DM-RS with which they overlap in at least one symbol and they are associated with same coresetPoolIndex, the UE is expected to prioritize the reception of PDCCH associated with that CORESET. This also applies to the intra-band CA case (when PDSCH and the CORESET are in different component carriers).

If a UE is configured with enableTwoDefaultTCI-States, and at least one TCI codepoint indicates two TCI states, the UE may assume that the DM-RS ports of PDSCH or PDSCH transmission occasions of a serving cell are quasi co-located with the RS(s) with respect to the QCL parameter(s) associated with the TCI states corresponding to the lowest codepoint among the TCI codepoints containing two different TCI states. When the UE is configured by higher layer parameter repetitionScheme set to ‘tdmSchemeA’ or is configured with higher layer parameter repetitionNumber, the mapping of the TCI states to PDSCH transmission occasions is determined according to clause 5.1.2.1 of 3GPP TS 38.214, e.g., by replacing the indicated TCI states with the TCI states corresponding to the lowest codepoint among the TCI codepoints containing two different TCI states based on the activated TCI states in the slot with the first PDSCH transmission occasion. In this case, if the ‘QCL-TypeD’ in both of the TCI states corresponding to the lowest codepoint among the TCI codepoints containing two different TCI states is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers).

In all cases above, if none of configured TCI states for the serving cell of scheduled PDSCH is configured with qcl-Type set to ‘typeD’, the UE shall obtain the other QCL assumptions from the indicated TCI states for its scheduled PDSCH irrespective of the time offset between the reception of the DL DCI and the corresponding PDSCH.

If the PDCCH carrying the scheduling DCI is received on one component carrier, and the PDSCH scheduled by that DCI is on another component carrier and the UE is configured with enableDefaultBeam-ForCCS:
The timeDurationForQCL is determined based on the subcarrier spacing of the scheduled PDSCH. If μPDCCH<μPDSCH an additional timing delay

$$d \frac{{2}^{{μ}_{PDSCH}}}{{2}^{{μ}_{PDCCH}}}$$

is added to the timeDurationForQCL, where d is defined in 5.2.1.5.la-1, otherwise d is zero;
For both the cases, when the offset between the reception of the DL DCI and the corresponding PDSCH is less than the threshold timeDurationForQCL, and when the DL DCI does not have the TCI field present, the UE obtains its QCL assumption for the scheduled PDSCH from the activated TCI state with the lowest ID applicable to PDSCH in the active BWP of the scheduled cell.

For a periodic CSI-RS resource in an NZP-CSI-RS-ResourceSet configured with higher layer parameter trs-Info, the UE shall expect that a TCI-State indicates one of the following quasi co-location type(s):
‘typeC’ with an SS/PBCH block and, when applicable, ‘typeD’ with the same SS/PBCH block, or. ‘typeC’ with an SS/PBCH block and, when applicable, ‘typeD’ with a CSI-RS resource in an NZP-CSI-RS-ResourceSet configured with higher layer parameter repetition, or

For an aperiodic CSI-RS resource in an NZP-CSI-RS-ResourceSet configured with

higher layer parameter trs-Info, the UE shall expect that a TCI-State indicates qcl-Type set to ‘typeA’ with a periodic CSI-RS resource in an NZP-CSI-RS-ResourceSet configured with higher layer parameter trs-Info and, when applicable, qcl-Type set to ‘typeD’ with the same periodic CSI-RS resource.

For a CSI-RS resource in an NZP-CSI-RS-ResourceSet configured without higher layer parameter trs-Info and without the higher layer parameter repetition, the UE shall expect that a TCI-State indicates one of the following quasi co-location type(s):
‘typeA’ with a CSI-RS resource in an NZP-CSI-RS-ResourceSet configured with higher layer parameter trs-Info and, when applicable, ‘typeD’ with the same CSI-RS resource, or
‘typeA’ with a CSI-RS resource in an NZP-CSI-RS-ResourceSet configured with higher layer parameter trs-Info and, when applicable, ‘typeD’ with an SS/PBCH block, or
‘typeA’ with a CSI-RS resource in an NZP-CSI-RS-ResourceSet configured with higher layer parameter trs-Info and, when applicable, ‘typeD’ with a CSI-RS resource in an NZP-CSI-RS-ResourceSet configured with higher layer parameter repetition, or
‘typeB’ with a CSI-RS resource in an NZP-CSI-RS-ResourceSet configured with higher layer parameter trs-Info when ‘typeD’ is not applicable.

For a CSI-RS resource in an NZP-CSI-RS-ResourceSet configured with higher layer parameter repetition, the UE shall expect that a TCI-State indicates one of the following quasi co-location type(s):
‘typeA’ with a CSI-RS resource in an NZP-CSI-RS-ResourceSet configured with higher layer parameter trs-Info and, when applicable, ‘typeD’ with the same CSI-RS resource, or
‘typeA’ with a CSI-RS resource in an NZP-CSI-RS-ResourceSet configured with higher layer parameter trs-Info and, when applicable, ‘typeD’ with a CSI-RS resource in an NZP-CSI-RS-ResourceSet configured with higher layer parameter repetition, or
‘typeC’ with an SS/PBCH block and, when applicable, ‘typeD’ with the same SS/PBCH block.

For the DM-RS of PDCCH, the UE shall expect that a TCI-State indicates one of the following quasi co-location type(s):
‘typeA’ with a CSI-RS resource in an NZP-CSI-RS-ResourceSet configured with higher layer parameter trs-Info and, when applicable, ‘typeD’ with the same CSI-RS resource, or
‘typeA’ with a CSI-RS resource in an NZP-CSI-RS-ResourceSet configured with higher layer parameter trs-Info and, when applicable, ‘typeD’ with a CSI-RS resource in an NZP-CSI-RS-ResourceSet configured with higher layer parameter repetition, or
‘typeA’ with a CSI-RS resource in an NZP-CSI-RS-ResourceSet configured without higher layer parameter trs-Info and without higher layer parameter repetition and, when applicable, ‘typeD’ with the same CSI-RS resource.

For the DM-RS of PDSCH, the UE shall expect that a TCI-State indicates one of the following quasi co-location type(s):
‘typeA’ with a CSI-RS resource in an NZP-CSI-RS-ResourceSet configured with higher layer parameter trs-Info and, when applicable, ‘typeD’ with the same CSI-RS resource, or
‘typeA’ with a CSI-RS resource in an NZP-CSI-RS-ResourceSet configured with higher layer parameter trs-Info and, when applicable, ‘typeD’ with a CSI-RS resource in an NZP-CSI-RS-ResourceSet configured with higher layer parameter repetition, or
typeA' with a CSI-RS resource in an NZP-CSI-RS-ResourceSet configured without higher layer parameter trs-Info and without higher layer parameter repetition and, when applicable, ‘typeD’ with the same CSI-RS resource.

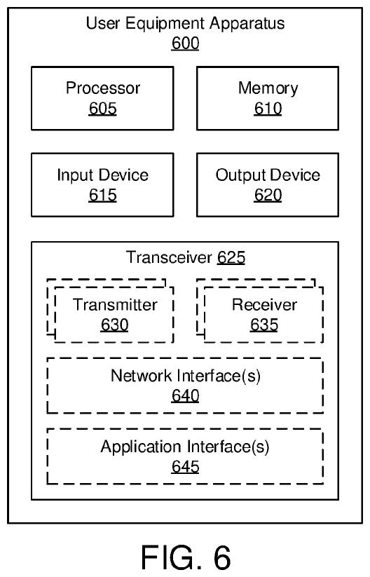

FIG. 6 depicts a user equipment apparatus 600 that may be used for semi-static channel access with directional FFP, according to embodiments of the disclosure. In various embodiments, the user equipment apparatus 600 is used to implement one or more of the solutions described above. The user equipment apparatus 600 may be one embodiment of a UE endpoint, such as the remote unit 105 and/or the UE 205, as described above. Furthermore, the user equipment apparatus 600 may include a processor 605, a memory 610, an input device 615, an output device 620, and a transceiver 625

In some embodiments, the input device 615 and the output device 620 are combined into a single device, such as a touchscreen. In certain embodiments, the user equipment apparatus 600 may not include any input device 615 and/or output device 620. In various embodiments, the user equipment apparatus 600 may include one or more of: the processor 605, the memory 610, and the transceiver 625, and may not include the input device 615 and/or the output device 620.

As depicted, the transceiver 625 includes at least one transmitter 630 and at least one receiver 635. In some embodiments, the transceiver 625 communicates with one or more cells (or wireless coverage areas) supported by one or more base units 121. In various embodiments, the transceiver 625 is operable on unlicensed spectrum. Moreover, the transceiver 625 may include multiple UE panels supporting one or more beams. Additionally, the transceiver 625 may support at least one network interface 640 and/or application interface 645. The application interface(s) 645 may support one or more APIs. The network interface(s) 640 may support 3GPP reference points, such as Uu, N1, PC5, etc. Other network interfaces 640 may be supported, as understood by one of ordinary skill in the art.

The processor 605, in one embodiment, may include any known controller capable of executing computer-readable instructions and/or capable of performing logical operations. For example, the processor 605 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 605 executes instructions stored in the memory 610 to perform the methods and routines described herein. The processor 605 is communicatively coupled to the memory 610, the input device 615, the output device 620, and the transceiver 625.

In various embodiments, the processor 605 controls the user equipment apparatus 600 to implement the above described UE behaviors. In certain embodiments, the processor 605 may include an application processor (also known as “main processor”) which manages application-domain and operating system (“OS”) functions and a baseband processor (also known as “baseband radio processor”) which manages radio functions.

In various embodiments, via the transceiver 625, the processor 605 receives a configuration for a plurality of FFPs, where each FFP is associated with a separate transmit beam for transmission within that FFP. The processor 605 identifies an initiated FFP and performs communication activity during the initiated FFP using a beam corresponding to the initiated FFP, where the communication activity includes a transmission, a reception, or a combination thereof.

In some embodiments, the plurality of FFPs at least partially overlap in time. In some embodiments, the processor 605 causes the transceiver 625 to transmit in an idle period of the initiated FFP using a beam that is not associated with the initiated FFP. In some embodiments, the configuration for the plurality of FFPs configures at least two simultaneous transmissions on two separate beams, where the processor 605 initiates at least two FFPs simultaneously corresponding to the two separate beams.

In some embodiments, the configuration for the plurality of FFPs configures a common FFP and, via the transceiver 625, the processor 605 A) performs a first CCA for the common FFP, and B) performs the communication activity in response to determining that the channel is clear based on the first CCA. In certain embodiments, via the transceiver 625, the processor 605 performs an additional CCA for a beam corresponding to at least one of the plurality of FFPs in response to determining that the channel is not clear based on the first CCA.

In some embodiments, via the transceiver 625, the processor 605 receives a semi-static association between a respective FFP and at least one respective beam. In some embodiments, the configuration for the plurality of FFPs indicates that a respective FFP can be associated with “X” number of beams, where the respective FFP can be initiated and used for transmission on any of the beams from the “X” number of associated beams.

In some embodiments, the apparatus 600 is a responding device configured to share a respective FFP initiated by an initiating device, where the processor 605 receives, via the transceiver 625, an association between the respective FFP and a respective beam for transmission by the responding device. In certain embodiments, the communication activity includes a scheduled transmission associated with a particular beam, where the processor 605 initiates a second FFP associated with the particular beam in response to determining that the respective FFP initiated by the initiating device is not associated with the particular beam.

In certain embodiments, to receive the association between the respective FFP and a respective beam for transmission by the responding device, via the transceiver 625, the processor 605 receives a semi-static configuration (e.g., RRC configuration) that indicates an association between a set of beams that can be used for transmission by the responding device and the respective FFP of the initiating device.

In certain embodiments, to receive the association between the respective FFP and a respective beam for transmission by the responding device, via the transceiver 625, the processor 605 receives dynamic signaling (e.g., UE-specific DCI, group-common DCI, or a combination thereof) that indicates an association between a set of beams that can be used for transmission by the responding device and the respective FFP of the initiating device.

In some embodiments, to perform the communication activity, the processor 605 indicates, e.g., via the transceiver 625, that a second device can transmit a second transmission within the initiated FFP in configured resources if the beam of the second transmission is associated with the initiated FFP.

In some embodiments, via the transceiver 625, the processor 605 receives scheduling information (e.g., via DCI) on a first FFP corresponding to a first beam, where the scheduling information schedules additional communication activity on a second FFP corresponding to a second beam, the additional communication activity including a transmission, a reception, or a combination thereof.

In certain embodiments, the first FFP is a RAN initiated FFP and where the second FFP is a RAN initiated FFP. In certain embodiments, the first FFP is a RAN initiated FFP and where the second FFP is a UE initiated FFP. In certain embodiments, the first FFP is a UE initiated FFP and where the second FFP is a RAN initiated FFP. In certain embodiments, the first FFP is a UE initiated FFP and where the second FFP is a UE initiated FFP.

The memory 610, in one embodiment, is a computer readable storage medium. In some embodiments, the memory 610 includes volatile computer storage media. For example, the memory 610 may include a RAM, including dynamic RAM (“DRAM”), synchronous dynamic RAM (“SDRAM”), and/or static RAM (“SRAM”). In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media.

In some embodiments, the memory 610 stores data related to semi-static channel access with directional FFP. For example, the memory 610 may store various parameters, panel/beam configurations, resource assignments, policies, and the like as described above. In certain embodiments, the memory 610 also stores program code and related data, such as an operating system or other controller algorithms operating on the user equipment apparatus 600.

The input device 615, in one embodiment, may include any known computer input device including a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, is designed to output visual, audible, and/or haptic signals. In some embodiments, the output device 620 includes an electronically controllable display or display device capable of outputting visual data to a user. For example, the output device 620 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 620 may include a wearable display separate from, but communicatively coupled to, the rest of the user equipment apparatus 600, such as a smart watch, smart glasses, a heads-up display, or the like. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all or portions of the output device 620 may be integrated with the input device 615. For example, the input device 615 and output device 620 may form a touchscreen or similar touch-sensitive display. In other embodiments, the output device 620 may be located near the input device 615.

The transceiver 625 communicates with one or more network functions of a mobile communication network via one or more access networks. The transceiver 625 operates under the control of the processor 605 to transmit messages, data, and other signals and also to receive messages, data, and other signals. For example, the processor 605 may selectively activate the transceiver 625 (or portions thereof) at particular times in order to send and receive messages.

The transceiver 625 includes at least transmitter 630 and at least one receiver 635. One or more transmitters 630 may be used to provide UL communication signals to a base unit 121, such as the UL transmissions described herein. Similarly, one or more receivers 635 may be used to receive DL communication signals from the base unit 121, as described herein. Although only one transmitter 630 and one receiver 635 are illustrated, the user equipment apparatus 600 may have any suitable number of transmitters 630 and receivers 635. Further, the transmitter(s) 630 and the receiver(s) 635 may be any suitable type of transmitters and receivers. In one embodiment, the transceiver 625 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 625, transmitters 630, and receivers 635 may be implemented as physically separate components that access a shared hardware resource and/or software resource, such as for example, the network interface 640.

In various embodiments, one or more transmitters 630 and/or one or more receivers 635 may be implemented and/or integrated into a single hardware component, such as a multi- transceiver chip, a system-on-a-chip, an Application-Specific Integrated Circuit (“ASIC”), or other type of hardware component. In certain embodiments, one or more transmitters 630 and/or one or more receivers 635 may be implemented and/or integrated into a multi-chip module. In some embodiments, other components such as the network interface 640 or other hardware components/circuits may be integrated with any number of transmitters 630 and/or receivers 635 into a single chip. In such embodiment, the transmitters 630 and receivers 635 may be logically configured as a transceiver 625 that uses one more common control signals or as modular transmitters 630 and receivers 635 implemented in the same hardware chip or in a multi-chip module.

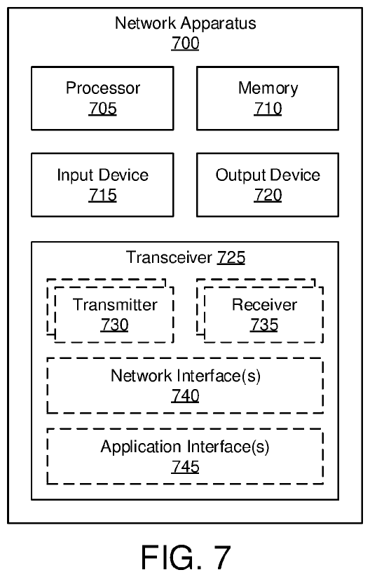

FIG. 7 depicts a network apparatus 700 that may be used for semi-static channel access with directional FFP, according to embodiments of the disclosure. In one embodiment, network apparatus 700 may be one implementation of a network endpoint, such as the base unit 121 and/or RAN node 210, as described above. Furthermore, the network apparatus 700 may include a processor 705, a memory 710, an input device 715, an output device 720, and a transceiver 725.

In some embodiments, the input device 715 and the output device 720 are combined into a single device, such as a touchscreen. In certain embodiments, the network apparatus 700 may not include any input device 715 and/or output device 720. In various embodiments, the network apparatus 700 may include one or more of: the processor 705, the memory 710, and the transceiver 725, and may not include the input device 715 and/or the output device 720.

As depicted, the transceiver 725 includes at least one transmitter 730 and at least one receiver 735. Here, the transceiver 725 communicates with one or more remote units 105. Additionally, the transceiver 725 may support at least one network interface 740 and/or application interface 745. The application interface(s) 745 may support one or more APIs. The network interface(s) 740 may support 3GPP reference points, such as Uu, N1, N2 and N3. Other network interfaces 740 may be supported, as understood by one of ordinary skill in the art.

The processor 705, in one embodiment, may include any known controller capable of executing computer-readable instructions and/or capable of performing logical operations. For example, the processor 705 may be a microcontroller, a microprocessor, a CPU, a GPU, an auxiliary processing unit, a FPGA, or similar programmable controller. In some embodiments, the processor 705 executes instructions stored in the memory 710 to perform the methods and routines described herein. The processor 705 is communicatively coupled to the memory 710, the input device 715, the output device 720, and the transceiver 725.

In various embodiments, the network apparatus 700 is a RAN node (e.g., gNB) that communicates with one or more UEs, as described herein. In such embodiments, the processor 705 controls the network apparatus 700 to perform the above described RAN behaviors. In some embodiments, the network apparatus 700 may configure one or more endpoint devices with the Training Sequences to be used in the key verification procedure. When operating as a RAN node, the processor 705 may include an application processor (also known as “main processor”) which manages application-domain and operating system (“OS”) functions and a baseband processor (also known as “baseband radio processor”) which manages radio functions.

In various embodiments, via the transceiver 725, the processor 705 transmits a configuration for a plurality of FFPs to a UE, where each FFP is associated with a separate transmit beam for transmission within that FFP. The processor 705 identifies an initiated FFP and performs communication activity with the UE during the initiated FFP using a beam corresponding to the initiated FFP, the communication activity including a transmission, a reception, or a combination thereof.

In some embodiments, the plurality of FFPs at least partially overlap in time. In some embodiments, the processor is further configured to cause the apparatus to transmit in an idle period of the initiated FFP using a beam that is not associated with the initiated FFP. In some embodiments, the configuration for the plurality of FFPs configures at least two simultaneous transmissions on two separate beams, where the processor is further configured to cause the apparatus to initiate at least two FFPs simultaneously corresponding to the two separate beams.

In some embodiments, the configuration for the plurality of FFPs configures a common FFP and, via the transceiver 725, the processor 705 A) performs a first CCA for the common FFP; and B) performs the communication activity in response to determining that the channel is clear based on the first CCA. In certain embodiments, via the transceiver 725, the processor 705 performs an additional CCA for a beam corresponding to at least one of the plurality of FFPs in response to determining that the channel is not clear based on the first CCA.

In some embodiments, via the transceiver 725, the processor 705 transmits a semi-static association between a respective FFP and at least one respective beam. In some embodiments, the configuration for the plurality of FFPs indicates that a respective FFP can be associated with “X” number of beams, where the respective FFP can be initiated and used for transmission on any of the beams from the “X” number of associated beams.

In some embodiments, the apparatus 700 is an initiating device configured to share a respective FFP with the UE, where the processor 705 transmits, via the transceiver 725, an association between the respective FFP and a respective beam for transmission by the UE. In certain embodiments, the communication activity includes a scheduled transmission associated with a particular beam, where the processor 705 initiates a second FFP associated with the particular beam in response to determining that the respective FFP initiated by the initiating device is not associated with the particular beam.

In certain embodiments, to transmit the association between the respective FFP and a respective beam for transmission by the responding device, via the transceiver 725, the processor 705 transmits a semi-static configuration (e.g., a RRC configuration) that indicates an association between a set of beams that can be used for transmission by the responding device and the respective FFP of the initiating device.

In certain embodiments, to transmit the association between the respective FFP and a respective beam for transmission by the responding device, via the transceiver 725, the processor 705 transmits dynamic signaling (e.g., UE-specific DCI, group-common DCI, or a combination thereof) that indicates an association between a set of beams that can be used for transmission by the responding device and the respective FFP of the initiating device.

In some embodiments, to perform the communication activity, the processor 705 indicates, e.g., via the transceiver 725, that a second device can transmit a second transmission within the initiated FFP in configured resources if the beam of the second transmission is associated with the initiated FFP.

In some embodiments, via the transceiver 725, the processor 705 transmits scheduling information (e.g., via DCI) on a first FFP corresponding to a first beam. In such embodiments, the scheduling information schedules additional communication activity on a second FFP corresponding to a second beam, where the additional communication activity includes a transmission, a reception, or a combination thereof.

In certain embodiments, the first FFP is a RAN initiated FFP and where the second FFP is a RAN initiated FFP. In certain embodiments, the first FFP is a RAN initiated FFP and where the second FFP is a UE initiated FFP. In certain embodiments, the first FFP is a UE initiated FFP and where the second FFP is a RAN initiated FFP. In certain embodiments, the first FFP is a UE initiated FFP and where the second FFP is a UE initiated FFP.

The memory 710, in one embodiment, is a computer readable storage medium. In some embodiments, the memory 710 includes volatile computer storage media. For example, the memory 710 may include a RAM, including dynamic RAM (“DRAM”), synchronous dynamic RAM (“SDRAM”), and/or static RAM (“SRAM”). In some embodiments, the memory 710 includes non-volatile computer storage media. For example, the memory 710 may include a hard disk drive, a flash memory, or any other suitable non-volatile computer storage device. In some embodiments, the memory 710 includes both volatile and non-volatile computer storage media.

In some embodiments, the memory 710 stores data related to semi-static channel access with directional FFP. For example, the memory 710 may store parameters, configurations, resource assignments, policies, and the like, as described above. In certain embodiments, the memory 710 also stores program code and related data, such as an operating system or other controller algorithms operating on the network apparatus 700.

The input device 715, in one embodiment, may include any known computer input device including a touch panel, a button, a keyboard, a stylus, a microphone, or the like. In some embodiments, the input device 715 may be integrated with the output device 720, for example, as a touchscreen or similar touch-sensitive display. In some embodiments, the input device 715 includes a touchscreen such that text may be input using a virtual keyboard displayed on the touchscreen and/or by handwriting on the touchscreen. In some embodiments, the input device 715 includes two or more different devices, such as a keyboard and a touch panel.

The output device 720, in one embodiment, is designed to output visual, audible, and/or haptic signals. In some embodiments, the output device 720 includes an electronically controllable display or display device capable of outputting visual data to a user. For example, the output device 720 may include, but is not limited to, an LCD display, an LED display, an OLED display, a projector, or similar display device capable of outputting images, text, or the like to a user. As another, non-limiting, example, the output device 720 may include a wearable display separate from, but communicatively coupled to, the rest of the network apparatus 700, such as a smart watch, smart glasses, a heads-up display, or the like. Further, the output device 720 may be a component of a smart phone, a personal digital assistant, a television, a table computer, a notebook (laptop) computer, a personal computer, a vehicle dashboard, or the like.

In certain embodiments, the output device 720 includes one or more speakers for producing sound. For example, the output device 720 may produce an audible alert or notification (e.g., a beep or chime). In some embodiments, the output device 720 includes one or more haptic devices for producing vibrations, motion, or other haptic feedback. In some embodiments, all or portions of the output device 720 may be integrated with the input device 715. For example, the input device 715 and output device 720 may form a touchscreen or similar touch-sensitive display. In other embodiments, the output device 720 may be located near the input device 715.

The transceiver 725 includes at least transmitter 730 and at least one receiver 735. One or more transmitters 730 may be used to communicate with the UE, as described herein. Similarly, one or more receivers 735 may be used to communicate with network functions in the Public Land Mobile Network (“PLMN”) and/or RAN, as described herein. Although only one transmitter 730 and one receiver 735 are illustrated, the network apparatus 700 may have any suitable number of transmitters 730 and receivers 735. Further, the transmitter(s) 730 and the receiver(s) 735 may be any suitable type of transmitters and receivers.

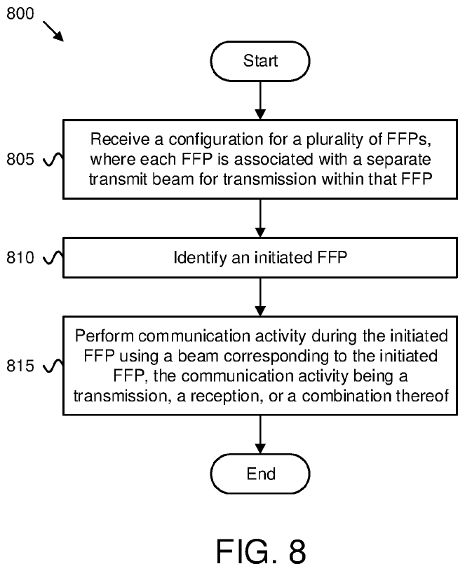

FIG. 8 depicts one embodiment of a method 800 for semi-static channel access with directional FFP, according to embodiments of the disclosure. In various embodiments, the method 800 is performed by a communication device, such as a remote unit 105, a UE 205, and/or the user equipment apparatus 600, described above, as described above. In some embodiments, the method 800 is performed by a processor, such as a microcontroller, a microprocessor, a CPU, a GPU, an auxiliary processing unit, a FPGA, or the like.

The method 800 begins and receives 805 a configuration for a plurality of FFPs, where each FFP is associated with a separate transmit beam for transmission within that FFP. The method 800 includes identifying 810 an initiated FFP. The method 800 includes performing 815 communication activity during the initiated FFP using a beam corresponding to the initiated FFP, where the communication activity includes a transmission, a reception, or a combination thereof. The method 800 ends.

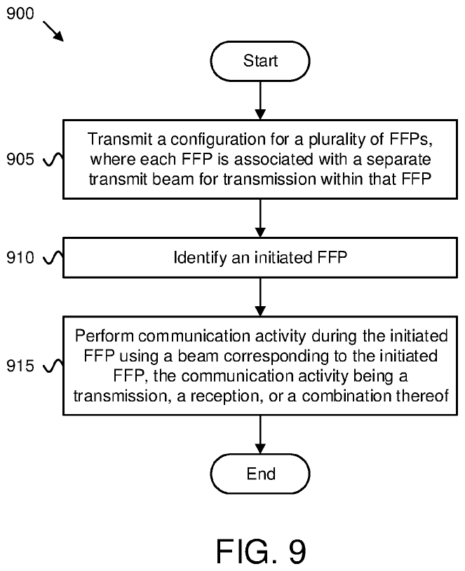

FIG. 9 depicts one embodiment of a method 900 for semi-static channel access with directional FFP, according to embodiments of the disclosure. In various embodiments, the method 900 is performed by an access network device, such as the base unit 121, the RAN node 210, and/or the network apparatus 700, as described above. In some embodiments, the method 900 is performed by a processor, such as a microcontroller, a microprocessor, a CPU, a GPU, an auxiliary processing unit, a FPGA, or the like.

The method 900 begins and transmits 905 a configuration for a plurality of FFPs to a UE, where each FFP is associated with a separate transmit beam for transmission within that FFP. The method 900 includes identifying 910 an initiated FFP. The method 900 includes performing 915 communication activity with the UE during the initiated FFP using a beam corresponding to the initiated FFP, where the communication activity includes a transmission, a reception, or a combination thereof. The method 900 ends.

Disclosed herein is a first apparatus for semi-static channel access with directional FFP, according to embodiments of the disclosure. The first apparatus may be implemented by a communication device, such as a remote unit 105, a UE 205, and/or the user equipment apparatus 600, described above. The first apparatus includes a processor coupled to a transceiver, the transceiver configured to communicate with a mobile communication network and the processor configured to cause the apparatus to: A) receive a configuration for a plurality of FFPs, where each FFP is associated with a separate transmit beam for transmission within that FFP; B) identify an initiated FFP; and C) perform communication activity during the initiated FFP using a beam corresponding to the initiated FFP, where the communication activity includes a transmission, a reception, or a combination thereof.

In some embodiments, the plurality of FFPs at least partially overlap in time. In some embodiments, the processor is further configured to cause the apparatus to transmit in an idle period of the initiated FFP using a beam that is not associated with the initiated FFP. In some embodiments, the configuration for the plurality of FFPs configures at least two simultaneous transmissions on two separate beams, where the processor is further configured to cause the apparatus to initiate at least two FFPs simultaneously corresponding to the two separate beams.

In some embodiments, the configuration for the plurality of FFPs configures a common FFP, where the processor is further configured to cause the apparatus to: A) perform a first CCA on a respective channel for the common FFP; and B) perform the communication activity in response to determining that the respective channel is clear based on the first CCA. In certain embodiments, the processor is further configured to cause the apparatus to perform an additional CCA for a respective beam corresponding to at least one of the plurality of FFPs in response to determining that the respective channel is not clear based on the first CCA.

In some embodiments, the processor is further configured to cause the apparatus to receive a semi-static association between a respective FFP and at least one respective beam. In some embodiments, the configuration for the plurality of FFPs indicates that a respective FFP can be associated with “X” number of beams, where the respective FFP can be initiated and used for transmission on any of the beams from the “X” number of associated beams.

In some embodiments, the first apparatus is a responding device configured to share a respective FFP initiated by an initiating device, where the processor is further configured to cause the apparatus to receive, by the responding device, an association between the respective FFP and a respective beam for transmission by the responding device. In certain embodiments, the communication activity includes a scheduled transmission associated with a particular beam, where the processor is further configured to cause the apparatus to initiate a second FFP associated with the particular beam in response to determining that the respective FFP initiated by the initiating device is not associated with the particular beam.

In certain embodiments, to receive the association between the respective FFP and the respective beam for transmission by the responding device, the processor is configured to cause the apparatus to receive a semi-static configuration (e.g., RRC configuration) that indicates a respective association between a set of beams that can be used for transmission by the responding device and the respective FFP of the initiating device.

In certain embodiments, to receive the association between the respective FFP and the respective beam for transmission by the responding device, the processor is configured to cause the apparatus to receive dynamic signaling (e.g., UE-specific DCI, group-common DCI, or a combination thereof) that indicates a respective association between a set of beams that can be used for transmission by the responding device and the respective FFP of the initiating device.

In some embodiments, to perform the communication activity, the processor is configured to cause the apparatus to indicate that a second device can transmit a second transmission within the initiated FFP in configured resources if the beam of the second transmission is associated with the initiated FFP.

In some embodiments, the processor is further configured to cause the apparatus to receive scheduling information (e.g., via DCI) on a first FFP corresponding to a first beam, where the scheduling information schedules additional communication activity on a second FFP corresponding to a second beam, the additional communication activity including a transmission, a reception, or a combination thereof.

In certain embodiments, the first FFP is a RAN initiated FFP and where the second FFP is a RAN initiated FFP. In certain embodiments, the first FFP is a RAN initiated FFP and where the second FFP is a UE initiated FFP. In certain embodiments, the first FFP is a UE initiated FFP and where the second FFP is a RAN initiated FFP. In certain embodiments, the first FFP is a UE initiated FFP and where the second FFP is a UE initiated FFP.

Disclosed herein is a first method for semi-static channel access with directional FFP, according to embodiments of the disclosure. The first method may be performed by a communication device, such as a remote unit 105, a UE 205, and/or the user equipment apparatus 600, described above. The first method includes receiving a configuration for a plurality of FFPs, where each FFP is associated with a separate transmit beam for transmission within that FFP. The first method includes identifying an initiated FFP and performing communication activity during the initiated FFP using a beam corresponding to the initiated FFP, where the communication activity includes a transmission, a reception, or a combination thereof.

In some embodiments, the plurality of FFPs at least partially overlap in time. In some embodiments, the first method includes transmitting in an idle period of the initiated FFP using a beam that is not associated with the initiated FFP. In some embodiments, the configuration for the plurality of FFPs configures at least two simultaneous transmissions on two separate beams. In such embodiments, the first method includes initiating at least two FFPs simultaneously corresponding to the two separate beams.

In some embodiments, the configuration for the plurality of FFPs configures a common FFP. In such embodiments, the first method further includes performing a first CCA on a respective channel for the common FFP and performing the communication activity in response to determining that the respective channel is clear based on the first CCA. In certain embodiments, the first method includes performing an additional CCA for a respective beam corresponding to at least one of the plurality of FFPs in response to determining that the respective channel is not clear based on the first CCA.

In some embodiments, the first method includes receiving a semi-static association between a respective FFP and at least one respective beam. In some embodiments, the configuration for the plurality of FFPs indicates that a respective FFP can be associated with ‘X’ number of beams, where the respective FFP can be initiated and used for transmission on any of the beams from the ‘X’ number of associated beams.

In some embodiments, the communication device is a responding device configured to share a respective FFP initiated by an initiating device. In such embodiments, the first method further includes receiving, by the responding device, an association between the respective FFP and a respective beam for transmission by the responding device. In certain embodiments, the communication activity includes a scheduled transmission associated with a particular beam. In such embodiments, the first method further including initiating a second FFP associated with the particular beam in response to determining that the respective FFP initiated by the initiating device is not associated with the particular beam.

In certain embodiments, receiving the association between the respective FFP and the respective beam for transmission by the responding device includes receiving a semi-static configuration (e.g., RRC configuration) that indicates a respective association between a set of beams that can be used for transmission by the responding device and the respective FFP of the initiating device.

In certain embodiments, receiving the association between the respective FFP and the respective beam for transmission by the responding device includes receiving dynamic signaling (e.g., UE-specific DCI, group-common DCI, or a combination thereof) that indicates a respective association between a set of beams that can be used for transmission by the responding device and the respective FFP of the initiating device.

In some embodiments, performing the communication activity includes indicating that a second device can transmit a second transmission within the initiated FFP in configured resources if the beam of the second transmission is associated with the initiated FFP.

In some embodiments, the first method includes receiving scheduling information (e.g., via DCI) on a first FFP corresponding to a first beam. In such embodiments, the scheduling information schedules additional communication activity on a second FFP corresponding to a second beam, where the additional communication activity includes a transmission, a reception, or a combination thereof.

In certain embodiments, the first FFP is a RAN initiated FFP and where the second FFP is a RAN initiated FFP. In certain embodiments, the first FFP is a RAN initiated FFP and where the second FFP is a UE initiated FFP. In certain embodiments, the first FFP is a UE initiated FFP and where the second FFP is a RAN initiated FFP. In certain embodiments, the first FFP is a UE initiated FFP and where the second FFP is a UE initiated FFP.

Disclosed herein is a second apparatus for semi-static channel access with directional FFP, according to embodiments of the disclosure. The second apparatus may be implemented by an access network device, such as the base unit 121, the RAN node 210, and/or the network apparatus 700, described above. The second apparatus includes a processor coupled to a transceiver, the transceiver configured to communicate with a communication device and the processor configured to cause the apparatus to: A) transmit a configuration for a plurality of FFPs to a UE, where each FFP is associated with a separate transmit beam for transmission within that FFP; B) identify an initiated FFP; and C) perform communication activity with the UE during the initiated FFP using a beam corresponding to the initiated FFP, the communication activity including a transmission, a reception, or a combination thereof.

In some embodiments, the plurality of FFPs at least partially overlap in time. In some embodiments, the processor is further configured to cause the apparatus to transmit in an idle period of the initiated FFP using a beam that is not associated with the initiated FFP. In some embodiments, the configuration for the plurality of FFPs configures at least two simultaneous transmissions on two separate beams, where the processor is further configured to cause the apparatus to initiate at least two FFPs simultaneously corresponding to the two separate beams.

In some embodiments, the configuration for the plurality of FFPs configures a common FFP, where the processor is further configured to cause the apparatus to: A) perform a first CCA on a respective channel for the common FFP; and B) perform the communication activity in response to determining that the respective channel is clear based on the first CCA. In certain embodiments, the processor is further configured to cause the apparatus to perform an additional CCA for a respective beam corresponding to at least one of the plurality of FFPs in response to determining that the respective channel is not clear based on the first CCA.

In some embodiments, the processor is further configured to cause the apparatus to transmit a semi-static association between a respective FFP and at least one respective beam. In some embodiments, the configuration for the plurality of FFPs indicates that a respective FFP can be associated with “X” number of beams, where the respective FFP can be initiated and used for transmission on any of the beams from the “X” number of associated beams.

In some embodiments, the second apparatus is an initiating device configured to share a respective FFP with the UE, where the processor is further configured to cause the apparatus to transmit, to the UE, an association between the respective FFP and a respective beam for transmission by the UE.

In certain embodiments, the communication activity includes a scheduled transmission associated with a particular beam, where the processor is further configured to cause the apparatus to initiate a second FFP associated with the particular beam in response to determining that the respective FFP initiated by the initiating device is not associated with the particular beam.

In certain embodiments, to transmit the association between the respective FFP and the respective beam for transmission by the responding device, the processor is configured to cause the apparatus to transmit a semi-static configuration (e.g., RRC configuration) that indicates a respective association between a set of beams that can be used for transmission by the responding device and the respective FFP of the initiating device.

In certain embodiments, to transmit the association between the respective FFP and the respective beam for transmission by the responding device, the processor is configured to cause the apparatus to transmit dynamic signaling (e.g., UE-specific DCI, group-common DCI, or a combination thereof) that indicates a respective association between a set of beams that can be used for transmission by the responding device and the respective FFP of the initiating device.

In some embodiments, to perform the communication activity, the processor is configured to cause the apparatus to indicate that a second device can transmit a second transmission within the initiated FFP in configured resources if the beam of the second transmission is associated with the initiated FFP.

In some embodiments, the processor is further configured to cause the apparatus to transmit scheduling information (e.g., via DCI) on a first FFP corresponding to a first beam. In such embodiments, the scheduling information schedules additional communication activity on a second FFP corresponding to a second beam, where the additional communication activity includes a transmission, a reception, or a combination thereof.

In certain embodiments, the first FFP is a RAN initiated FFP and where the second FFP is a RAN initiated FFP. In certain embodiments, the first FFP is a RAN initiated FFP and where the second FFP is a UE initiated FFP. In certain embodiments, the first FFP is a UE initiated FFP and where the second FFP is a RAN initiated FFP. In certain embodiments, the first FFP is a UE initiated FFP and where the second FFP is a UE initiated FFP.

Disclosed herein is a second method for semi-static channel access with directional FFP, according to embodiments of the disclosure. The second method may be performed by an access network device, such as the base unit 121, the RAN node 210, and/or the network apparatus 700, described above. The second method includes transmitting a configuration for a plurality of FFPs to a UE, where each FFP is associated with a separate transmit beam for transmission within that FFP. The second method includes identifying an initiated FFP and performing communication activity with the UE during the initiated FFP using a beam corresponding to the initiated FFP, where the communication activity includes a transmission, a reception, or a combination thereof.

In some embodiments, the plurality of FFPs at least partially overlap in time. In some embodiments, the second method includes transmit in an idle period of the initiated FFP using a beam that is not associated with the initiated FFP. In some embodiments, the configuration for the plurality of FFPs configures at least two simultaneous transmissions on two separate beams. In such embodiments, the second method further includes initiating at least two FFPs simultaneously corresponding to the two separate beams.

In some embodiments, the configuration for the plurality of FFPs configures a common FFP. In such embodiments, the second method further includes perform a first CCA on a respective channel for the common FFP and perform the communication activity in response to determining that the respective channel is clear based on the first CCA. In certain embodiments, the second method further includes perform an additional CCA for a respective beam corresponding to at least one of the plurality of FFPs in response to determining that the respective channel is not clear based on the first CCA.

In some embodiments, the second method includes transmitting a semi-static association between a respective FFP and at least one respective beam. In some embodiments, the configuration for the plurality of FFPs indicates that a respective FFP can be associated with “X” number of beams, where the respective FFP can be initiated and used for transmission on any of the beams from the “X” number of associated beams.

In some embodiments, the access network device is an initiating device configured to share a respective FFP with the UE. In such embodiments, the second method further includes transmitting, to the UE, an association between the respective FFP and a respective beam for transmission by the UE. In certain embodiments, the communication activity includes a scheduled transmission associated with a particular beam. In such embodiments, the second method further includes initiating a second FFP associated with the particular beam in response to determining that the respective FFP initiated by the initiating device is not associated with the particular beam.

In certain embodiments, transmitting the association between the respective FFP and the respective beam for transmission by the responding device includes transmitting a semi-static configuration (e.g., RRC configuration) that indicates a respective association between a set of beams that can be used for transmission by the responding device and the respective FFP of the initiating device.

In certain embodiments, transmitting the association between the respective FFP and the respective beam for transmission by the responding device includes transmitting dynamic signaling (e.g., UE-specific DCI, group-common DCI, or a combination thereof) that indicates a respective association between a set of beams that can be used for transmission by the responding device and the respective FFP of the initiating device.

In some embodiments, performing the communication activity includes indicating that a second device can transmit a second transmission within the initiated FFP in configured resources if the beam of the second transmission is associated with the initiated FFP.

In some embodiments, the second method includes transmitting scheduling information (e.g., via DCI) on a first FFP corresponding to a first beam. In such embodiments, the scheduling information schedules additional communication activity on a second FFP corresponding to a second beam, where the additional communication activity includes a transmission, a reception, or a combination thereof.

In certain embodiments, the first FFP is a RAN initiated FFP and where the second FFP is a RAN initiated FFP. In certain embodiments, the first FFP is a RAN initiated FFP and where the second FFP is a UE initiated FFP. In certain embodiments, the first FFP is a UE initiated FFP and where the second FFP is a RAN initiated FFP. In certain embodiments, the first FFP is a UE initiated FFP and where the second FFP is a UE initiated FFP.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A communication apparatus comprising:
a transceiver; and
a processor coupled with the transceiver, the processor configured to cause the apparatus to:
receive a configuration for a plurality of fixed frame periods (“FFPs”), wherein each FFP is associated with a separate transmit beam for transmission within that FFP;
identify an initiated FFP; and
perform communication activity during the initiated FFP using a beam corresponding to the initiated FFP, the communication activity comprising a transmission, a reception, or a combination thereof.

2. The apparatus of claim 1, wherein the plurality of FFPs at least partially overlap in time.

3. The apparatus of claim 1, wherein the processor is further configured to cause the apparatus to transmit in an idle period of the initiated FFP using a beam that is not associated with the initiated FFP.

4. The apparatus of claim 1, wherein the configuration for the plurality of FFPs configures a common FFP, wherein the processor is further configured to cause the apparatus to:
perform a first clear channel assessment (“CCA”) on a respective channel for the common FFP; and
perform the communication activity in response to determining that the respective channel is clear based on the first CCA.

5. The apparatus of claim 4, wherein the processor is further configured to cause the apparatus to perform an additional CCA for a respective beam corresponding to at least one of the plurality of FFPs in response to determining that the respective channel is not clear based on the first CCA.

6. The apparatus of claim 1, wherein the configuration for the plurality of FFPs configures at least two simultaneous transmissions on two separate beams, wherein the processor is further configured to cause the apparatus to initiate at least two FFPs simultaneously corresponding to the two separate beams.

7. The apparatus of claim 1, wherein the processor is further configured to cause the apparatus to receive a semi-static association between a respective FFP and at least one respective beam.

8. The apparatus of claim 1, wherein the configuration for the plurality of FFPs indicates that a respective FFP can be associated with “X” number of beams, wherein the respective FFP can be initiated and used for transmission on any of the beams from the “X” number of associated beams.

9. The apparatus of claim 1, wherein the apparatus is a responding device configured to share a respective FFP initiated by an initiating device, wherein the processor is further configured to cause the apparatus to receive, by the responding device, an association between the respective FFP and a respective beam for transmission by the responding device.

10. The apparatus of claim 9, wherein, to receive the association between the respective FFP and the respective beam for transmission by the responding device, the processor is configured to cause the apparatus to receive a semi-static configuration that indicates a respective association between a set of beams that can be used for transmission by the responding device and the respective FFP of the initiating device.

11. The apparatus of claim 9, wherein, to receive the association between the respective FFP and the respective beam for transmission by the responding device, the processor is configured to cause the apparatus to receive dynamic signaling that indicates a respective association between a set of beams that can be used for transmission by the responding device and the respective FFP of the initiating device.

12. The apparatus of claim 9, wherein the communication activity comprises a scheduled transmission associated with a particular beam, wherein the processor is further configured to cause the apparatus to initiate a second FFP associated with the particular beam in response to determining that the respective FFP initiated by the initiating device is not associated with the particular beam.

13. A method of a communication device, the method comprising:
receiving a configuration for a plurality of fixed frame periods (“FFPs”), wherein each FFP is associated with a separate transmit beam for transmission within that FFP;
identifying an initiated FFP; and
performing communication activity during the initiated FFP using a beam corresponding to the initiated FFP, the communication activity comprising a transmission, a reception, or a combination thereof.

14. A communication apparatus comprising:
a transceiver; and
a processor coupled with the transceiver, the processor configured to cause the apparatus to:
transmit a configuration for a plurality of fixed frame periods (“FFPs”) to a User Equipment (“UE”), wherein each FFP is associated with a separate transmit beam for transmission within that FFP;
identify an initiated FFP; and
perform communication activity with the UE during the initiated FFP using a beam corresponding to the initiated FFP, the communication activity comprising a transmission, a reception, or a combination thereof.

15. The apparatus of claim 14, wherein the communication apparatus is an initiating device configured to share a respective FFP with the UE, wherein the processor is further configured to cause the apparatus to transmit, to the UE, an association between the respective FFP and a respective beam for transmission by the UE.
